(19) United States
(12) Patent Application Publication
(10) Pub. No.: US 2018/0018006 A1
(43) Pub. Date: Jan. 18, 2018

(54) INFORMATION PROCESSING APPARATUS AND PROCESSOR

(71) Applicant: FUJITSU LIMITED, Kawasaki-shi (JP)

(72) Inventor: Yusuke Kudo, Kawasaki (JP)

(73) Assignee: FUJITSU LIMITED, Kawasaki-shi (JP)

(21) Appl. No.: 15/715,696

(22) Filed: Sep. 26, 2017

Related U.S. Application Data
(63) Continuation of application No. PCT/JP2015/063117, filed on May 1, 2015.

(51) Int. Cl. G06F 1/20; G06F 1/32; G06F 3/06; G06F 11/30

(52) U.S. Cl. CPC G06F 1/206; G06F 11/3089; G06F 11/3058; G06F 1/3275; G06F 3/0664; G06F 3/0631; G06F 11/3037

(57) ABSTRACT

An information processing apparatus includes: a temperature sensor and a processor. The temperature sensor measures temperatures of a plurality of memory modules. The processor changes memory addresses of the plurality of memory modules such that temperatures of the plurality of memory modules are equalized, the memory addresses of the plurality of memory modules being associated with memory addresses of pages that are assigned to a virtual memory in which the plurality of memory modules are virtually available.

### CROSS-REFERENCE TO RELATED APPLICATION

This application is a continuation application of International Application PCT/JP 2015/063117 filed on May 1, 2015 and designated the U.S., the entire contents of which are incorporated herein by reference.

### FIELD

The embodiments discussed herein are related to a virtualization technology.

### BACKGROUND

A virtualization technology is known that provides physical resources such as a central processing unit (CPU) or a memory to an operating system (OS) or an application as a virtual device.

A technology is known that improves a memory access throughput by moving a page for a memory module, among pages for a plurality of memory modules, that is in a heated state to a memory module that is not in a heated state (see, for example, Patent document 1)

A technology is known that limits the amount of power and the thermal load consumed by an individual memory component (see, for example, Patent document 2). Memory allocation to portions of dynamic random access memory (DRAM) and dual in-line memory module (DIMM) devices that are underutilized is redistributed.

A technology is known that reduces a concentration of current and heat in a memory module that includes a plurality of memory chips stacked on top of one another (see, for example, Patent document 3). Each of the plurality of memory chips includes a memory cell unit that is divided into a plurality of blocks, and an address scrambling circuit that processes an input address signal and selects a block to be operated.

Patent document 1: Japanese Laid-open Patent Publication No. 2012-185764

Patent document 2: Japanese Laid-open Patent Publication No. 2007-133879

Patent document 3: Japanese Laid-open Patent Publication No. 2013-114644

### SUMMARY

According to an aspect of the invention, an information processing apparatus includes: a temperature sensor and a processor. The temperature sensor measures temperatures of a plurality of memory modules. The processor changes memory addresses of the plurality of memory modules such that temperatures of the plurality of memory modules are equalized, the memory addresses of the plurality of memory modules being associated with memory addresses of pages that are assigned to a virtual memory in which the plurality of memory modules are virtually available.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an example of page remapping processing according to embodiments;

FIG. 2 illustrates an example of a hardware configuration of an information processing apparatus according to the embodiments;

FIG. 3 illustrates an example of a virtual environment and a VMM according to the embodiments;

FIG. 4 illustrates an example of memory modules before remapping is performed;

FIG. 5A illustrates an example of a temperature list generated by performing remapping processing;

FIG. 5B illustrates an example of the temperature list generated by performing remapping processing;

FIG. 5C illustrates an example of the temperature list generated by performing remapping processing;

FIG. 5D illustrates an example of the temperature list generated by performing remapping processing;

FIG. 6A is a diagram for explaining an example of processing of optimizing the temperature list;

FIG. 6B is a diagram for explaining the example of the processing of optimizing the temperature list;

FIG. 7A is a diagram for explaining an example of processing of generating a procedure list;

FIG. 7B is a diagram for explaining the example of the processing of generating a procedure list;

FIG. 7C is a diagram for explaining the example of the processing of generating a procedure list;

FIG. 7D is a diagram for explaining the example of the processing of generating a procedure list;

FIG. 7E is a diagram for explaining the example of the processing of generating a procedure list;

FIG. 7F is a diagram for explaining the example of the processing of generating a procedure list;

FIG. 7G is a diagram for explaining the example of the processing of generating a procedure list;

FIG. 8 is a flowchart that illustrates an example (Part 1) of processing of generating a temperature list;

FIG. 9 is a flowchart that illustrates the example (Part 2) of the processing of generating a temperature list;

FIG. 10 is a flowchart that illustrates the example (Part 3) of the processing of generating a temperature list;

FIG. 11 is a flowchart that illustrates the example of the processing of optimizing the temperature list;

FIG. 12 is a flowchart that illustrates the example of the processing of generating a procedure list;

FIG. 13 illustrates a second example of memory modules before remapping is performed;

FIG. 14A is a diagram for explaining a second example of the processing of generating a temperature list;

FIG. 14B is a diagram for explaining the second example of the processing of generating a temperature list;

FIG. 14C is a diagram for explaining the second example of the processing of generating a temperature list;

FIG. 14D is a diagram for explaining the second example of the processing of generating a temperature list;

FIG. 14E is a diagram for explaining the second example of the processing of generating a temperature list;

FIG. 14F is a diagram for explaining the second example of the processing of generating a temperature list;

FIG. 14G is a diagram for explaining the second example of the processing of generating a temperature list;

FIG. 14H is a diagram for explaining the second example of the processing of generating a temperature list;

FIG. 14I is a diagram for explaining the second example of the processing of generating a temperature list;

FIG. 14J is a diagram for explaining the second example of the processing of generating a temperature list;

FIG. 15 illustrates the second example of the memory modules after remapping is performed;

FIG. 16 illustrates an example of memory modules according to a second embodiment;

FIG. 17 illustrates an example of memory modules according to a third embodiment;

FIG. 18 is a diagram for explaining a temperature state of a memory module according to a fourth embodiment; and

FIG. 19 is a diagram for explaining an example of processing of obtaining a combination of pages according to the fourth embodiment.

### DESCRIPTION OF EMBODIMENTS

Embodiments will now be described in detail with reference to the drawings.

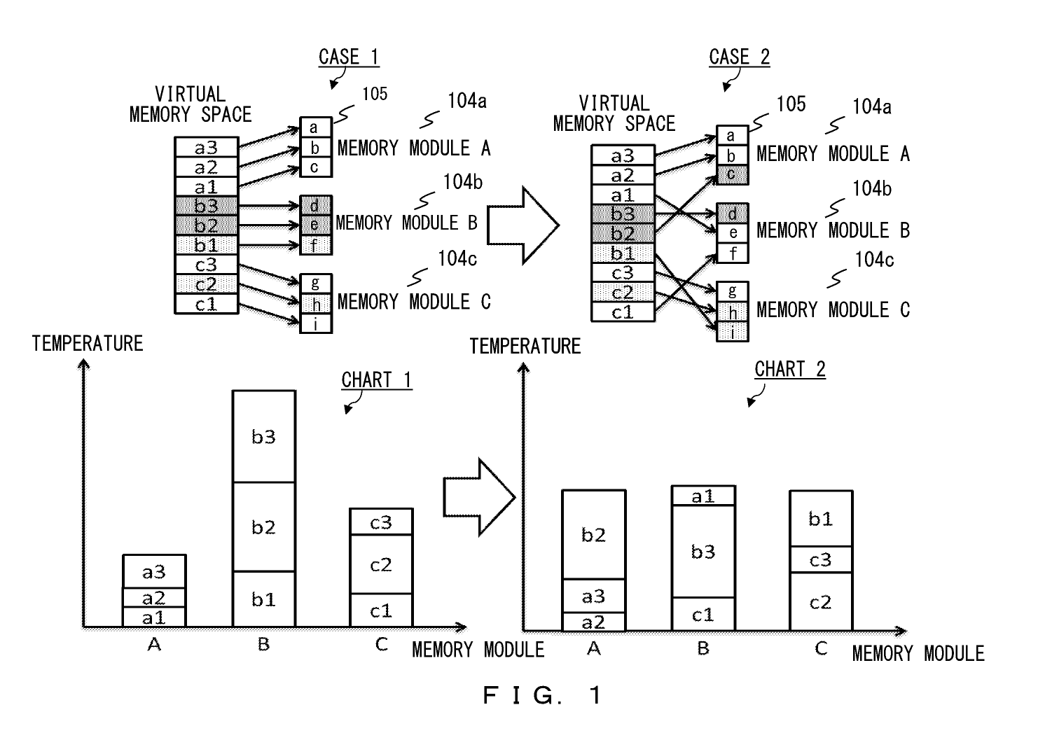

FIG. 1 is a diagram for explaining an example of page remapping processing according to embodiments. A case 1 is an example of memory modules 104a to 104c before page remapping is performed. The remapping is processing of changing a physical memory address of a memory module that is set as a virtual memory address of a page. Each memory module 104 (104a to 104c) has a configuration in which a plurality of semiconductor memory chips 105 (hereinafter referred to as memory chips) are mounted and wired on a substrate, and are provided with a connection terminal for establishing a connection to an information processing apparatus. The memory module 104a includes memory chips 105a to 105c. The memory module 104b includes memory chips 105d to 105f. The memory module 104c includes memory chips 105g to 105i. The memory chips 105a to 105i are connected to a temperature sensor and temperatures of the memory chips 105a to 105i are measured by the temperature sensor.

In a virtual environment in which a memory module is used as a virtual memory, a virtual memory includes a plurality of pages (pages a1 to a3, pages b1 to b3, and pages c1 to c3). The memory chip 105a of the memory module 104a is assigned as a virtual memory address of the page a3. The memory chip 105b of the memory module 104a is assigned as a virtual memory address of the page a2. The memory chip 105c of the memory module 104a is assigned as a virtual memory address of the page a1. The memory chip 105d of the memory module 104b is assigned as a virtual memory address of the page b3. The memory chip 105e of the memory module 104b is assigned as a virtual memory address of the page b2. The memory chip 105f of the memory module 104b is assigned as a virtual memory address of the page b1. The memory chip 105g of the memory module 104c is assigned as a virtual memory address of the page c3. The memory chip 105h of the memory module 104c is assigned as a virtual memory address of the page c2. The memory chip 105i of the memory module 104c is assigned as a virtual memory address of the page c1.

The memory modules 104a to 104c in the case 1 are given on the abscissa axis of a chart 1. The sum of the temperatures of memory chips included in each of the memory modules 104a to 104c are given on the ordinate axis of the chart 1. The sum of the temperatures of the memory chips 105a to 105c (to which the pages a1 to a3 are assigned, respectively) is defined to be a temperature of the memory module 104a. The sum of the temperatures of the memory chips 105d to 105f (to which the pages b1 to b3 are assigned, respectively) is defined to be a temperature of the memory module 104b. The sum of the temperatures of the memory chips 105g to 105i (to which the pages c1 to c3 are assigned, respectively) is defined to be a temperature of the memory module 104c. An amount of heat generation is more increased and a temperature is easily increased in a page (memory chip), among the pages a1 to c3, that includes data accessed more frequently.

Here, in the case 1, the temperature of the memory module 104b is higher than the temperatures of the memory modules 104a and 104c. The temperature of the memory module 104b is high, so when the memory modules 104a to 104c are cooled by, for example, a cooling fan, the memory module 104a is cooled more than is needed by the cooling fan although the temperature of the memory module 104a is already low, which results in unneeded consumption of power.

In order to reduce unneeded consumption of power, an information processing apparatus according to the embodiments performs processing of equalizing the temperatures of the memory modules 104 by optimizing a mapping of the pages to the memory modules 104.

A case 2 and a chart 2 explain an example of the memory modules 104a to 104c after page remapping is performed. When remapping is performed, the temperatures of the memory modules 104a to 104c are equalized as in the chart 2. The memory modules 104a to 104c in the case 2 are given on the abscissa axis of the chart 2. The sum of the temperatures of the memory chips included in each of the memory modules 104a to 104c are given on the ordinate axis of the chart 2. The temperature of the memory module 104a is the sum of the temperatures of the memory chips 105a to 105c (to which the pages b2, a3, and a2 are assigned, respectively). The temperature of the memory module 104b is the sum of the temperatures of the memory chips 105d to 105f (to which the pages a1, b3, and c1 are assigned, respectively). The temperature of the memory module 104c is the sum of the temperatures of the memory chips 105g to 105i (to which the pages b1, c3, and c2 are assigned, respectively).

As a result of remapping, the pages assigned to the memory modules 104a to 104c in the case 2 are different from the pages assigned to the modules 104a to 104c in the case 1. In the case 2, the memory chip 105a of the memory module 104a is assigned as a virtual memory address of the page a3. The memory chip 105b of the memory module 104a is assigned as a virtual memory address of the page a2. The memory chip 105e of the memory module 104b is assigned as a virtual memory address of the page a1. The memory chip 105d of the memory module 104b is assigned as a virtual memory address of the page b3. The memory chip 105c of the memory module 104a is assigned as a virtual memory address of the page b2. The memory chip 105i of the memory module 104c is assigned as a virtual memory address of the page b1. The memory chip 105g of the memory module 104c is assigned as a virtual memory address of the page c3. The memory chip 105h of the memory module 104c is assigned as a virtual memory address of the page c2. The memory chip 105f of the memory module 104b is assigned as a virtual memory address of the page c1.

When the temperatures of the memory modules 104a to 104c are not greater than a predetermined threshold, it is possible to reduce a cooling fan speed. This results in being able to reduce Thus, compared with the case 1, the information processing apparatus provided with the memory module of the case 2 can reduce consumption of power used for cooling.

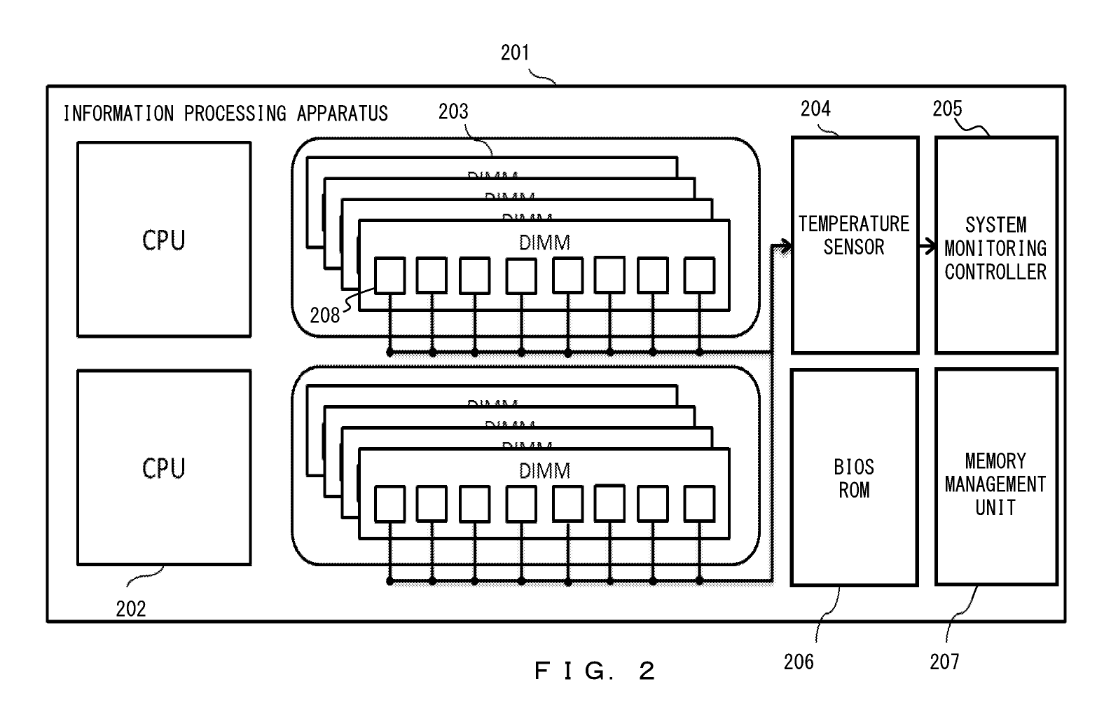

FIG. 2 illustrates an example of a hardware configuration of the information processing apparatus according to the embodiments. An information processing apparatus 201 includes a CPU 202, a DIMM 203, a temperature sensor 204, a system monitoring controller 205, a BIOS ROM 206, and a memory management unit 207.

The CPU 202 executes a program that is called by the DIMM 203. The DIMM 203 is a memory module. A plurality of DIMMs 203 may be provided in the information processing apparatus 201. The DIMM 203 includes a plurality of memory chips 208. The memory chip 208 stores therein data treated in the information processing apparatus 201.

The temperature sensor 204 is connected to each memory chip 208, and measures a temperature of the memory chip 208 at regular time intervals. The system monitoring controller 205 obtains information on a temperature of a memory chip that is measured by the temperature sensor 204 so as to monitor the temperature of a memory chip.

The BIOS ROM 206 stores therein, for example, a control program that is, for example, a virtual machine monitor (VMM) that provides virtualization functions. The VMM is a control program that virtualizes physical resources such as the CPU 202 and a memory module such as the DIMM 203, so as to provide the physical resources to a virtual environment as virtual resources such as a virtual CPU and a virtual memory. The environment created by virtualized devices such as a virtual CPU and a virtual memory is hereinafter referred to as a virtual environment.

For example, the VMM associates a physical memory address of a memory module with a virtual memory address of a virtual memory, so as to provide physical resources such as a memory module as virtual resources such as a virtual memory. When the VMM is called by the DIMM 203 from the BIOS ROM 206, the VMM enters into an executable state, so as to be executed by the CPU 202. The memory management unit 207 controls page remapping processing.

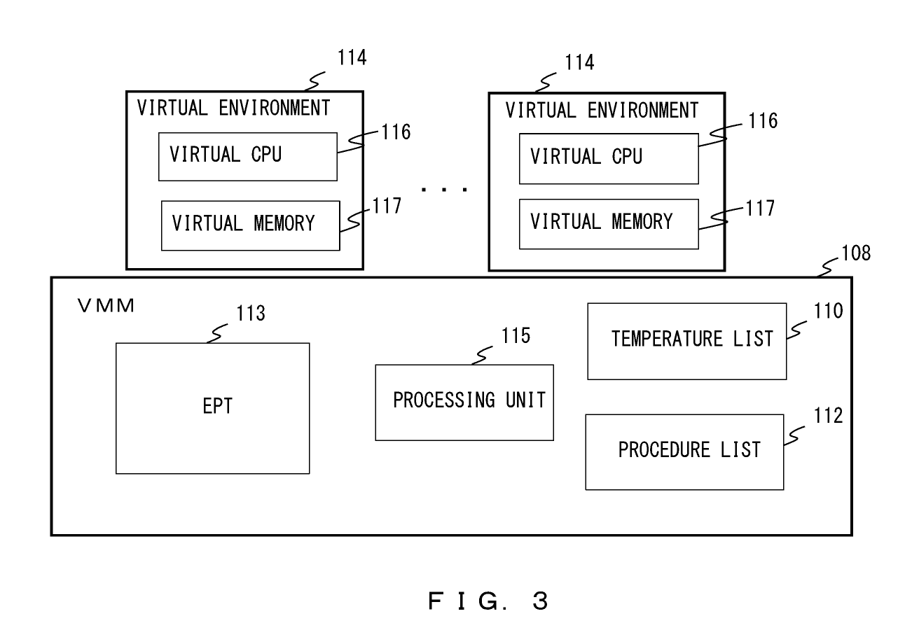

FIG. 3 illustrates an example of a virtual environment and a VMM according to the embodiments. A VMM 108 virtualizes physical resources such as memory modules such as the CPU 202 and the DIMM 203, so as to provide the physical resources to a virtual environment 114 as virtual resources such as a virtual CPU 116 and a virtual memory 117. Processing performed in the VMM 108 is performed according to the instruction given by a processing unit 115.

When a user uses the virtual environment 114, what the user can use is the virtual memory 117 obtained by virtualization performed by the VMM 108, not a memory module that is a physical resource. The user can set up the virtual memory 117 discretionarily. An extended page table (EPT) 113 is a table in which a virtual memory address in a virtual environment is associated with a physical address of a memory module. A physical address that corresponds to a virtual memory address is given in an entry of the EPT 113. Thus, the memory management unit 207 can assign a different page as a page for a memory module associated with a virtual environment by changing a physical address that corresponds to a virtual memory address.

A temperature list 110 is information that is used when processing of changing a combination of a physical memory address of a memory module and a virtual memory address of a page is performed such that the temperature of a memory module is close to an average value (equalized). A procedure list 112 is information that indicates a changing order when the physical memory address that corresponds to a certain virtual memory address is changed.

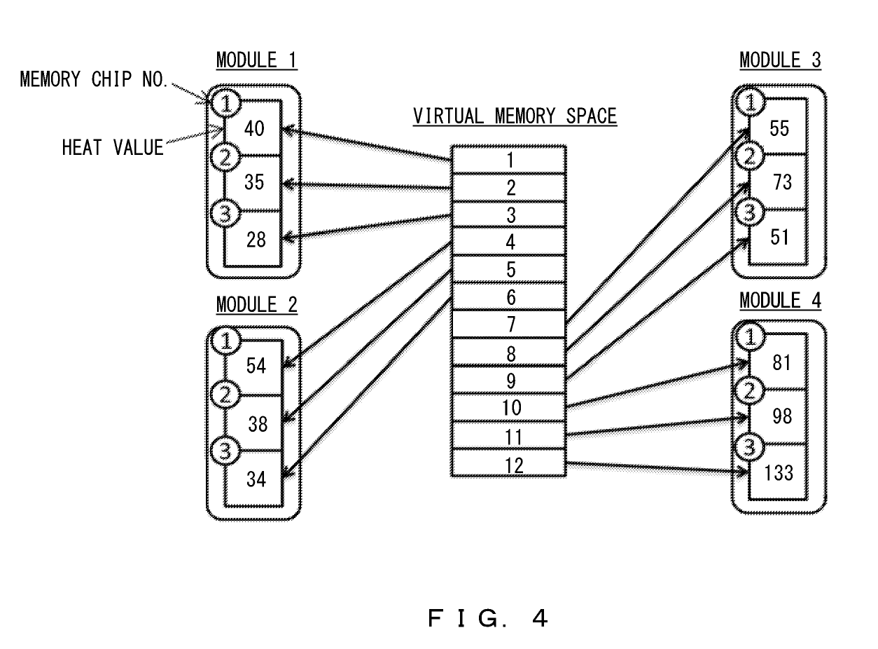

FIG. 4 illustrates an example of memory modules before remapping is performed. A memory module 1 of FIG. 4 includes memory chips having memory chip numbers 1 to 3. The memory chip having a memory chip number 1 in the memory module 1 is associated with a page 1 of a virtual memory, and the amount of heat generation (the temperature) of this memory chip is 40 degrees. The memory chip having a memory chip number 2 in the memory module 1 is associated with a page 2 of the virtual memory, and the amount of heat generation (the temperature) of this memory chip is 35 degrees. The memory chip having a memory chip number 3 in the memory module 1 is associated with a page 3 of the virtual memory, and the amount of heat generation (the temperature) of this memory chip is 28 degrees.

A memory chip having a memory chip number 1 in a memory module 2 is associated with a page 4 of the virtual memory, and the amount of heat generation (the temperature) of this memory chip is 54 degrees. A memory chip having a memory chip number 2 in the memory module 2 is associated with a page 5 of the virtual memory, and the amount of heat generation (the temperature) of this memory chip is 38 degrees. A memory chip having a memory chip number 3 in the memory module 2 is associated with a page 6 of the virtual memory, and the amount of heat generation (the temperature) of this memory chip is 34 degrees.

A memory chip having a memory chip number 1 in a memory module 3 is associated with a page 7 of the virtual memory, and the amount of heat generation (the temperature) of this memory chip is 55 degrees. A memory chip having a memory chip number 2 in the memory module 3 is associated with a page 8 of the virtual memory, and the amount of heat generation (the temperature) of this memory chip is 73 degrees. A memory chip having a memory chip number 3 in the memory module 3 is associated with a page 9 of the virtual memory, and the amount of heat generation (the temperature) of this memory chip is 51 degrees.

A memory chip having a memory chip number 1 in a memory module 4 is associated with a page 10 of the virtual memory, and the amount of heat generation (the temperature) of this memory chip is 81 degrees. A memory chip having a memory chip number 2 in the memory module 4 is associated with a page 11 of the virtual memory, and the amount of heat generation (the temperature) of this memory chip is 98 degrees. A memory chip having a memory chip number 3 in the memory module 4 is associated with a page 12 of the virtual memory, and the amount of heat generation (the temperature) of this memory chip is 133 degrees.

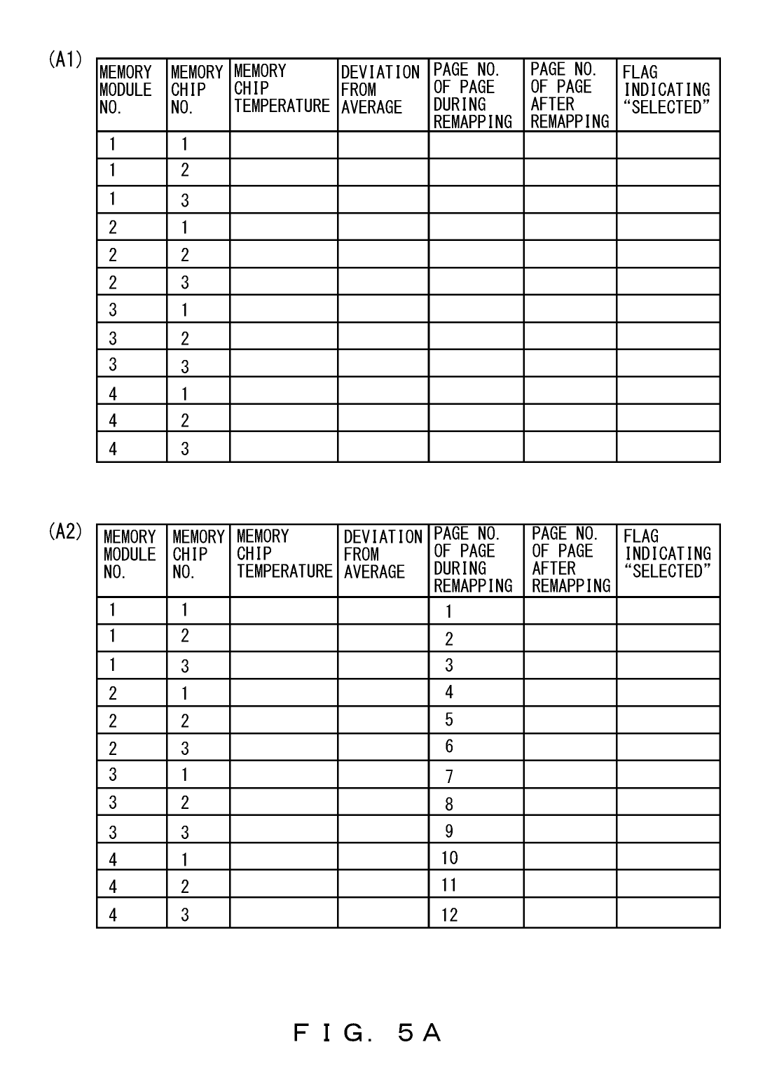

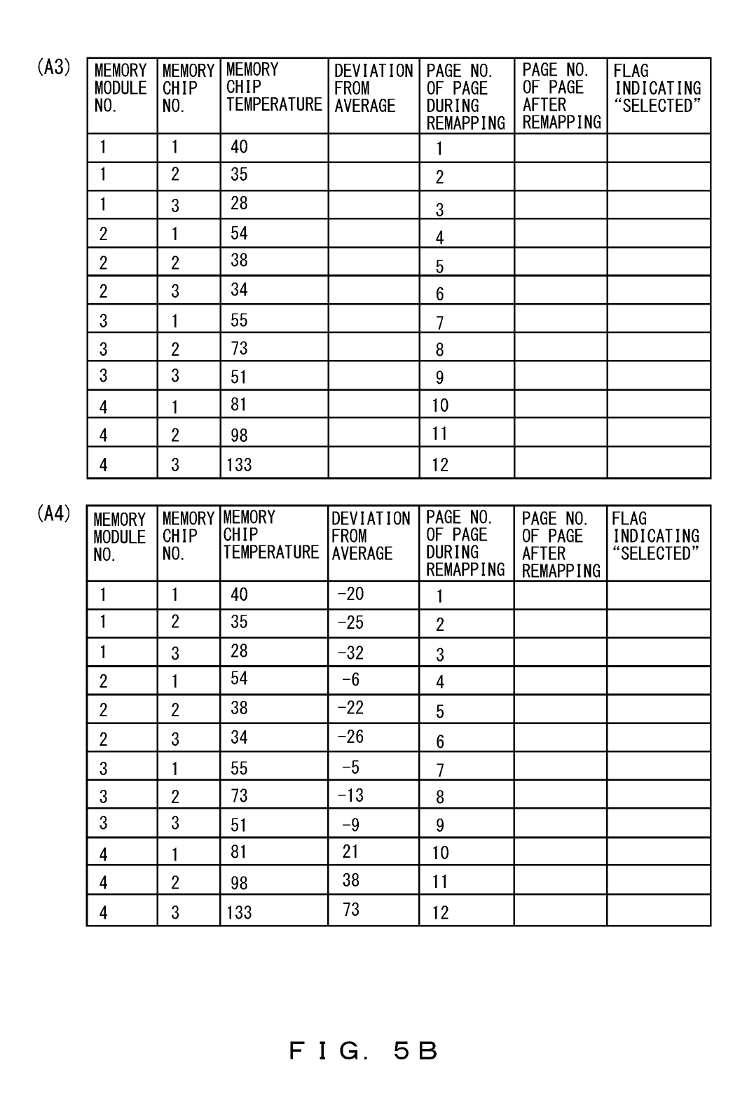

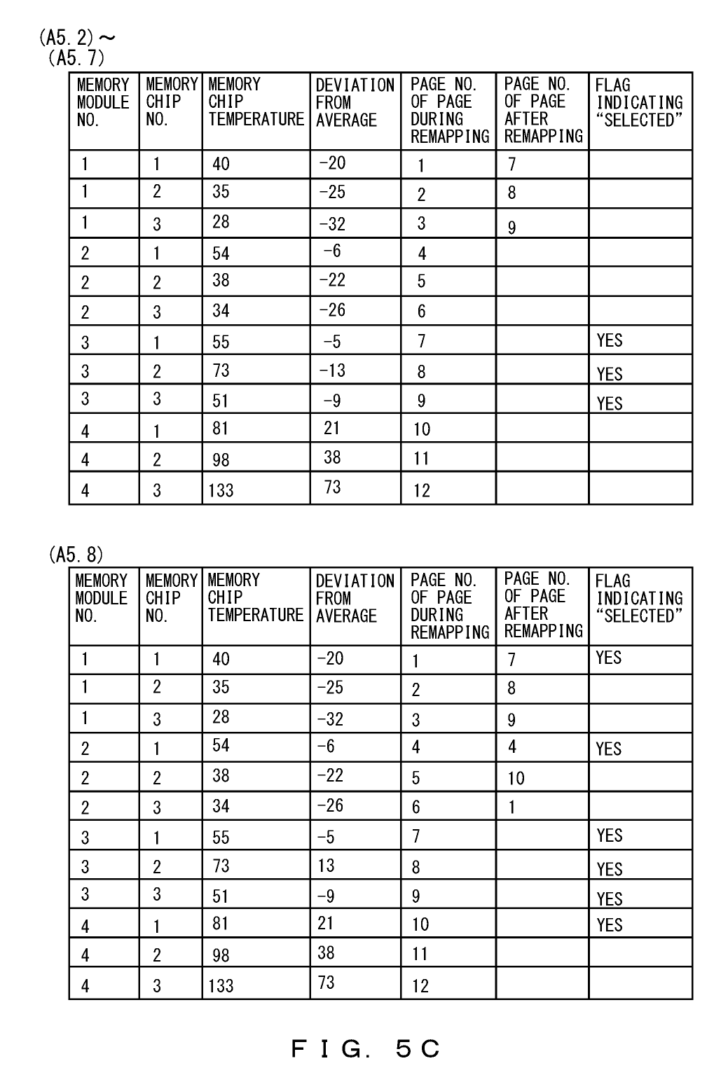

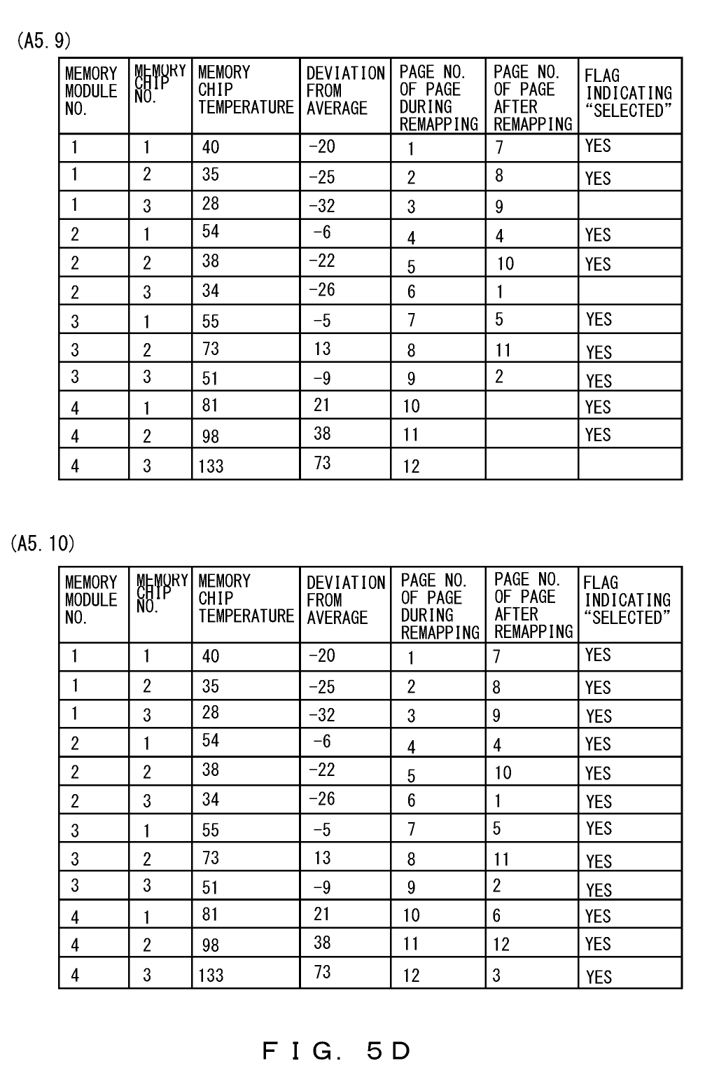

FIGS. 5A to 5D illustrate examples of a temperature list generated by remapping processing. When the processing of changing a combination of a physical memory address of a memory module and a virtual memory address of a page is performed such that the temperature of a memory module is close to an average value (equalized) is started, a temperature list is generated according to the state of a memory module. An example of processing of selecting, by use of a temperature list, a combination of a physical memory address of a memory module and a virtual memory address of a page is performed such that the temperature of a memory module is close to an average value (equalized) is described below.

(A1) The processing unit 115 generates a temperature list from the state of a memory module and the state of a virtual memory before remapping is performed. The temperature list includes categories such as a memory module number, a memory chip number, a memory chip temperature, a deviation from an average, a page number of a page during remapping, a page number of a page after remapping, and information on a flag indicating “selected”. The processing unit 115 sets the memory module number and the memory chip number in the temperature list according to the state of a memory module and the state of a virtual memory illustrated in FIG. 4. In the following descriptions, a page number of a page for a memory module before remapping is referred to as a “page during remapping” that indicates a page that is now being remapped, and a number that identifies the page is referred to as a “page number of a page during remapping”. (A2) Based on the EPT 113, the processing unit 115 sets, in the category of the page number of a page during remapping in the temperature list, a number that identifies a page with which each memory chip is associated.

(A3) The processing unit 115 obtains information that is a temperature of each memory chip from the system monitoring controller 205. The processing unit 115 sets the obtained temperature of each memory chip in the category of the memory chip temperature in the temperature list. The information in (A1) to (A3) is information based on the state of a memory module in FIG. 4.

(A4) The processing unit 115 calculates an average temperature of the obtained temperatures of all of the memory chips. After that, the processing unit 115 calculates a deviation of the temperature of each of the memory chips from the average temperature. The deviation from an average temperature is a value that is obtained by subtracting an average temperature of memory chips from a temperature of a memory chip and that indicates how far the temperature of the memory chip is from the average. The processing unit 115 sets, in the category of the deviation from an average in the temperature list, the calculated deviation of the temperature of each memory chip from the average temperature.

(A5) The processing unit 115 starts processing of selecting a page number of a page assigned to each memory chip after remapping is performed.

(A5.1) First, the processing unit 115 sets an accumulated value to 0.

(A5.2) The processing unit 115 selects a page number of a page during remapping in which a value obtained by adding the corresponding deviation from an average to the accumulated value is closest to “0”. Here, the processing unit 115 selects the page number “7” of a page during remapping because the deviation “−5” is closest to 0. The processing unit 115 sets, in the category of the flag indicating “selected” in the temperature list, information indicating that the page number “7” of a page during remapping has been selected. The processing unit 115 adds the deviation “−5” that corresponds to the selected page number “7” of a page during remapping to the accumulated value “0”. As a result, the accumulated value becomes “−5”.

(A5.3) The processing unit 115 sets the selected page number “7” of a page during remapping in an uppermost blank space in the category of the page number of a page after remapping in the temperature list.

Here, each of the memory modules in FIG. 4 is provided with three memory chips, so the processing unit 115 selects, from the temperature list, three page numbers of a page during remapping in which a value obtained by adding the corresponding three deviations from an average is closest to “0”. Thus, the processing unit 115 performs processes of (A5.4) to (A5.7).

(A5.4) The processing unit 115 selects a page number of a page during remapping in which a value obtained by adding the corresponding deviation from an average to the accumulated value “−5” is closest to “0”. Here, the processing unit 115 selects the page number “8” of a page during remapping because a value obtained by adding the deviation “13” to the accumulated value “−5” is closest to 0. The processing unit 115 sets, in the category of the flag indicating “selected” in the temperature list, information indicating that the page number “8” of a page during remapping has been selected. The processing unit 115 adds the deviation “13” that corresponds to the selected page number “8” of a page during remapping to the accumulated value “−5”. As a result, the accumulated value becomes “8”.

(A5.5) The processing unit 115 sets the selected page number “8” of a page during remapping in an uppermost blank space in the category of the page number of a page after remapping in the temperature list.

(A5.6) The processing unit 115 selects a page number of a page during remapping in which a value obtained by adding the corresponding deviation from an average to the accumulated value “8” is closest to “0”. Here, the processing unit 115 selects the page number “9” of a page during remapping because a value obtained by adding the deviation “−9” to the accumulated value “8” is closest to 0. The processing unit 115 sets, in the category of the flag indicating “selected” in the temperature list, information indicating that the page number “9” of a page during remapping has been selected. The processing unit 115 adds the deviation “−9” that corresponds to the selected page number “9” of a page during remapping to the accumulated value “8”. As a result, the accumulated value becomes “−1”.

(A5.7) The processing unit 115 sets the selected page number “9” of a page during remapping in an uppermost blank space in the category of the page number of a page after remapping in the temperature list.

When pages for one memory module have been selected by performing the processes of (A5.1) to (A5.7), processing of selecting pages for a next memory module is performed. The processing unit 115 performs the processes of (A5.1) to (A5.7) until a selection for all of the memory chips is completed. The processes of (A5.8) to (A5.10) are an example of repeated processing.

(A5.8) The processing unit 115 selects a page number of a page during remapping in which a value obtained by adding the corresponding deviation from an average to the accumulated value is closest to “0”. The processing unit 115 sets the selected page numbers “4, 10, and 1” of a page during remapping in blank spaces, from an uppermost blank space, of the category of the page number of a page after remapping in the temperature list. The processing unit 115 sets, in the category of the flag indicating “selected” in the temperature list, information indicating that the page numbers “4, 10, and 1” of a page during remapping have been selected.

(A5.9) The processing unit 115 selects a page number of a page during remapping in which a value obtained by adding the corresponding deviation from an average to the accumulated value is closest to “0”. The processing unit 115 sets the selected page numbers “5, 11, and 2” of a page during remapping in blank spaces, from an uppermost blank space, of the category of the page number of a page after remapping in the temperature list. The processing unit 115 sets, in the category of the flag indicating “selected” in the temperature list, information indicating that the page numbers “5, 11, and 2” of a page during remapping have been selected.

(A5.10) The processing unit 115 selects a page number of a page during remapping in which a value obtained by adding the corresponding deviation from an average to the accumulated value is closest to “0”. The processing unit 115 sets the selected page numbers “6, 12, and 3” of a page during remapping in blank spaces, from an uppermost blank space, of the category of the page number of a page after remapping in the temperature list. The processing unit 115 sets, in the category of the flag indicating “selected” in the temperature list, information indicating that the page numbers “6, 12, and 3” of a page during remapping have been selected.

As described above, it is possible to select a combination of pages in which the temperature of each memory module is equalized by selecting a combination of three page numbers of a page during remapping in which the sum of the corresponding three deviations is close to 0. The memory management unit 207 changes a combination of a virtual memory address of a page and a physical memory address of a memory chip according to the selected combination of pages. Specifically, the memory management unit 207 associates the page numbers “7, 8, and 9” of a page during remapping with the memory chips 1 to 3 of the memory module 1. The memory management unit 207 associates the page numbers “4, 10, and 1” of a page during remapping with the memory chips 1 to 3 of the memory module 2. The memory management unit 207 associates the page numbers “5, 11, and 2” of a page during remapping with the memory chips 1 to 3 of the memory module 3. The memory management unit 207 associates the page numbers “6, 12, and 3” of a page during remapping with the memory chips 1 to 3 of the memory module 4. Accordingly, it is possible to equalize the temperature of a memory module (the sum of the temperatures in each memory module is close to an average value), which results in reducing power consumption due to cooling the memory modules.

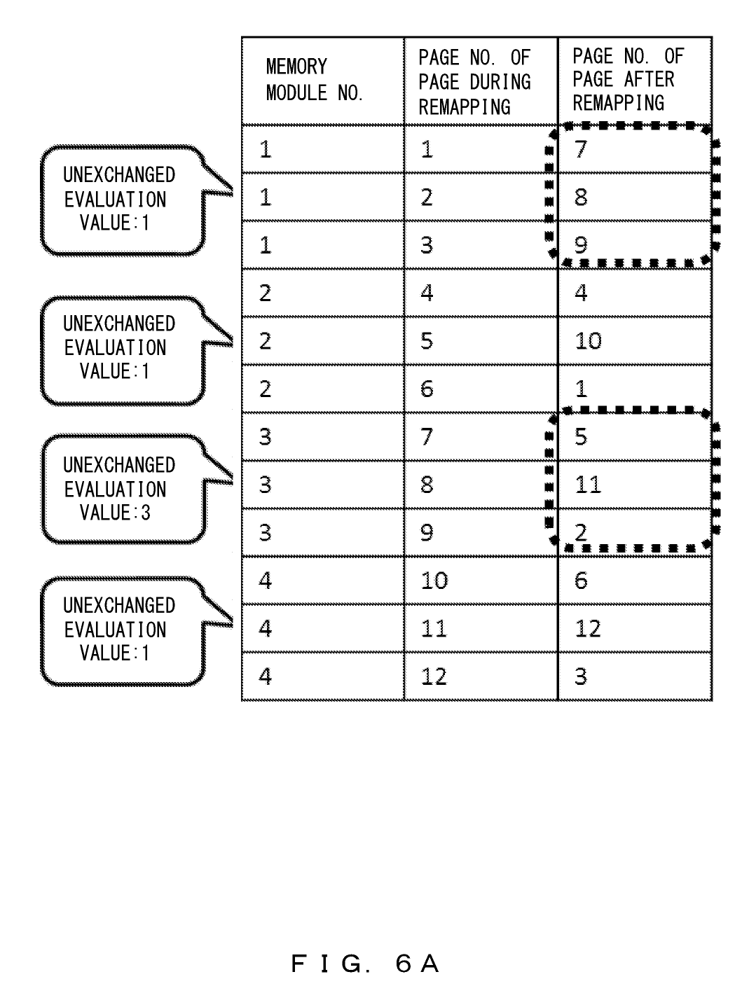

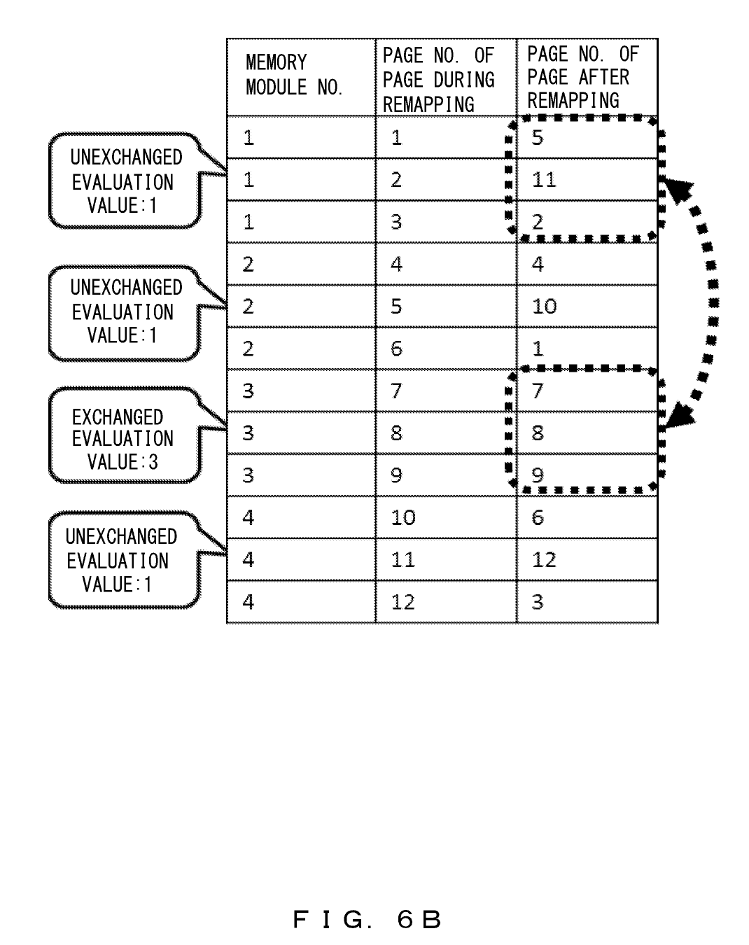

FIGS. 6A and 6B are diagrams for explaining an example of processing of optimizing the temperature list. It is possible to bring the sum of the temperatures in each memory module close to an average by associating a physical memory address of a memory chip with a virtual memory address of a page according to the temperature list of FIG. 5. However, page exchange processing is not taken into consideration in the temperature list of FIG. 5, and remapping in which the number of page exchanges is smaller is preferable because the burden on an information processing apparatus is lighter. Processing for reducing the number of page exchanges is described sequentially below.

(B1) The processing unit 115 evaluates page numbers of a page during remapping that is associated with each memory module in the temperature list. Specifically, the processing unit 115 evaluates how pages that are mapped to a certain memory module at present are grouped after remapping is performed. For example, with respect to the page numbers “7, 8, and 9” of a page during remapping for the memory module 3, all the three page numbers are assigned to the memory module 1 in the category of the page number of a page after remapping, so the processing unit 115 assigns the evaluation value 3 to the memory module 3. With respect to the page numbers “1, 2, and 3” of a page during remapping for the memory module 1, the page numbers “4, 5, and 6” of a page during remapping for the memory module 2, and the page numbers “10, 11, and 12” of a page during remapping for the memory module 4, the page numbers for each of the memory modules are separately assigned to different memory modules after remapping is performed, so the evaluation value 1 is assigned to these modules (see FIG. 6A). Here, if remapping is performed without taking into consideration the number of page exchanges, all of the pages for the memory module 3 will be moved to the memory module 1, which results in performing unneeded remapping processing.

(B2) As illustrated in FIG. 6B, a memory module with a large evaluation value (that is not less than 2) is selected preferentially and the same pages are assigned to the selected memory module after remapping is performed. A flag indicating “exchanged” is set for the memory module to which assignment has been performed.

(B3) When processing of reassignment (B2) is completed with respect to a memory module having an evaluation not less than 2, the processing unit 115 terminates the processing for reducing the number of page exchanges.

As described above, when there is a combination of pages after remapping that is associated with a certain memory module and is similar to a combination of pages during remapping that was associated with another memory module, it is preferable that the combination of pages after remapping be associated with the another memory module because it is possible to reduce the number of page exchanges.

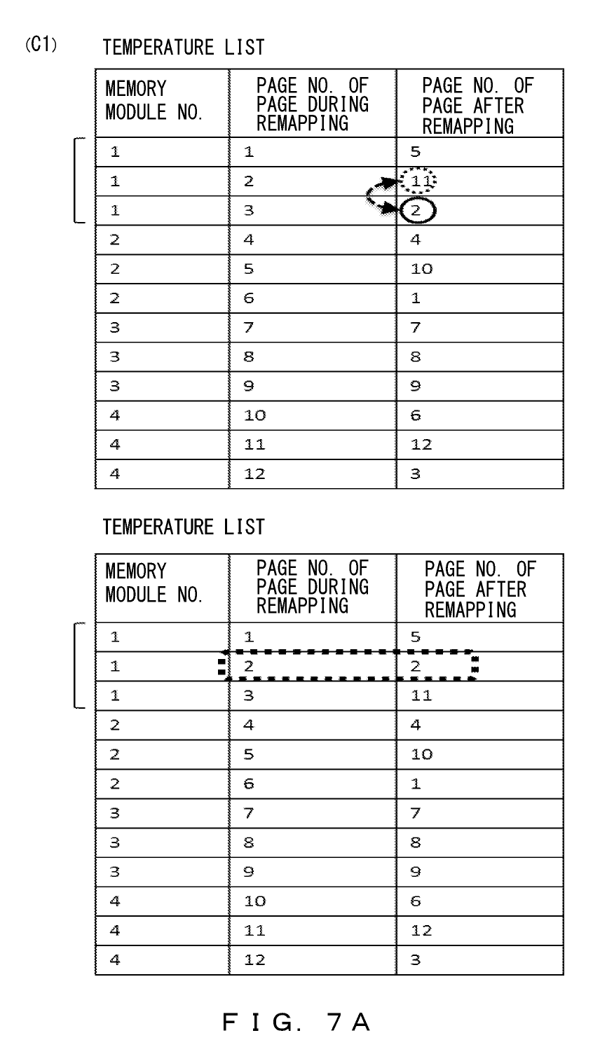

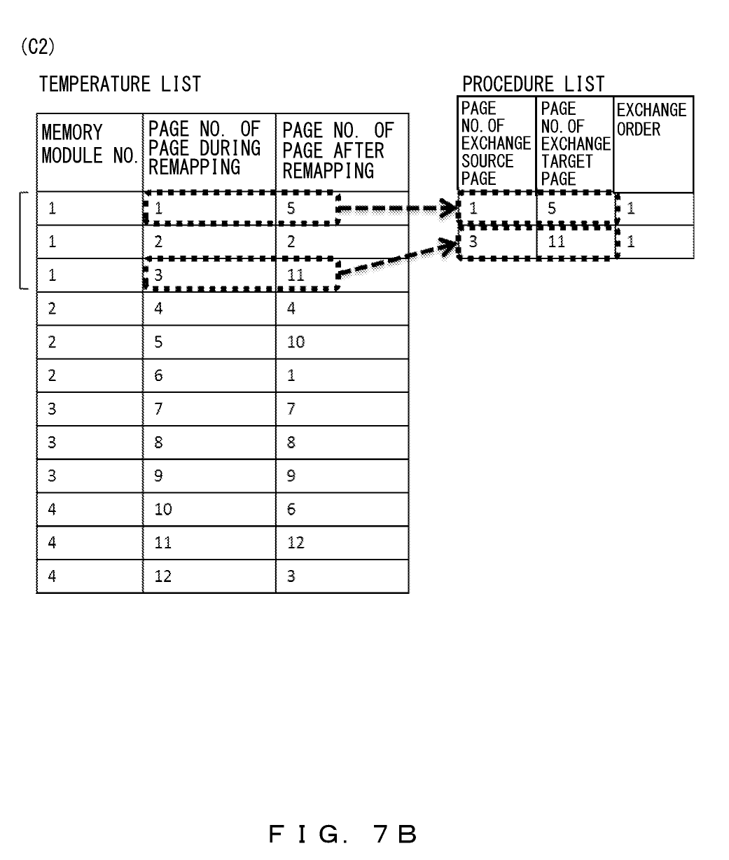

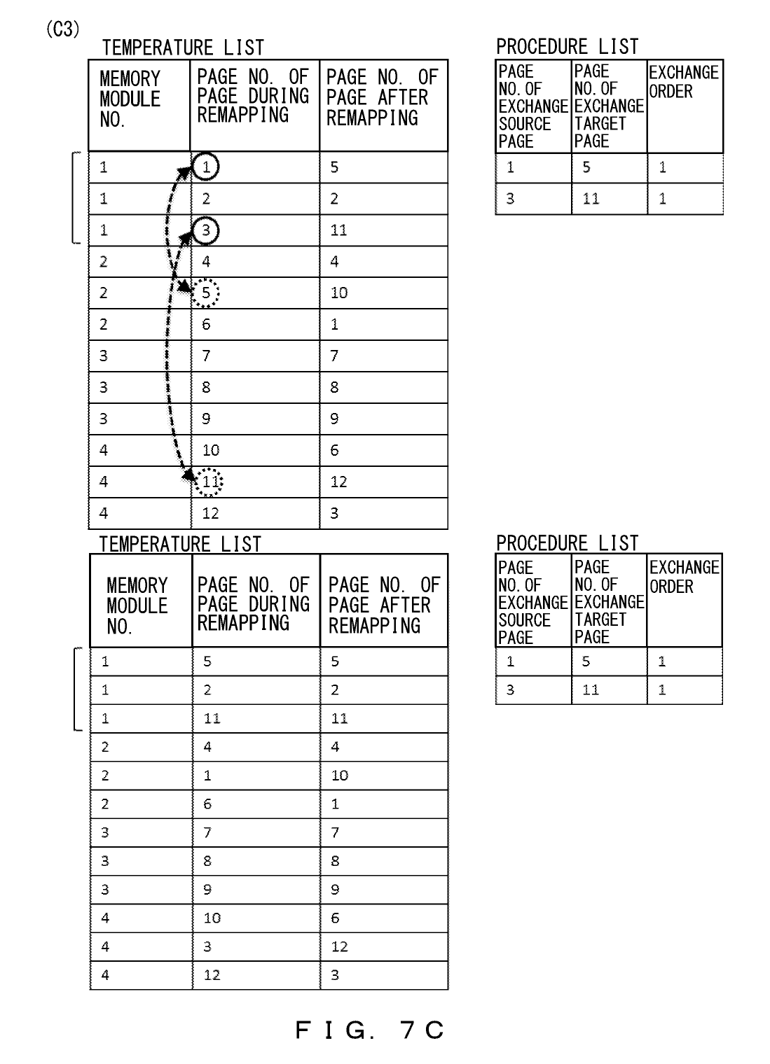

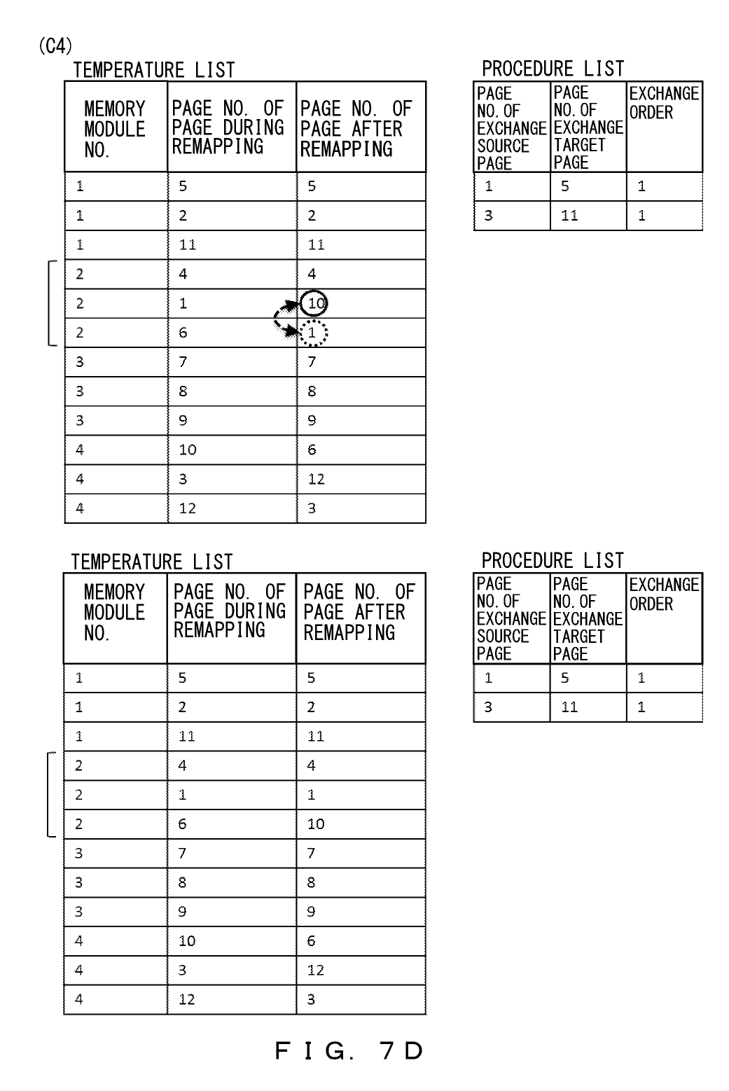

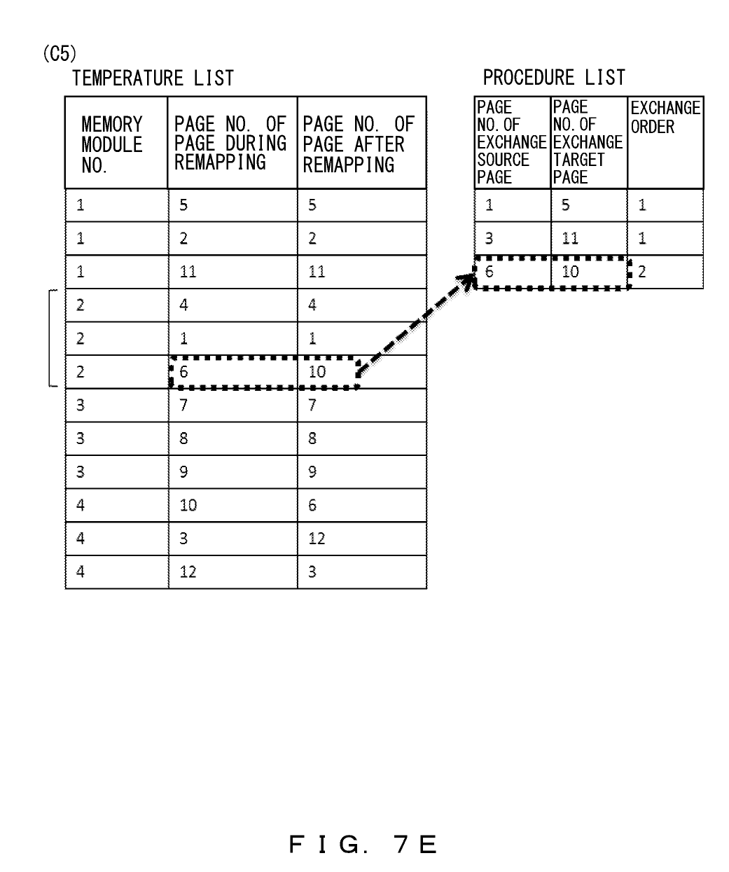

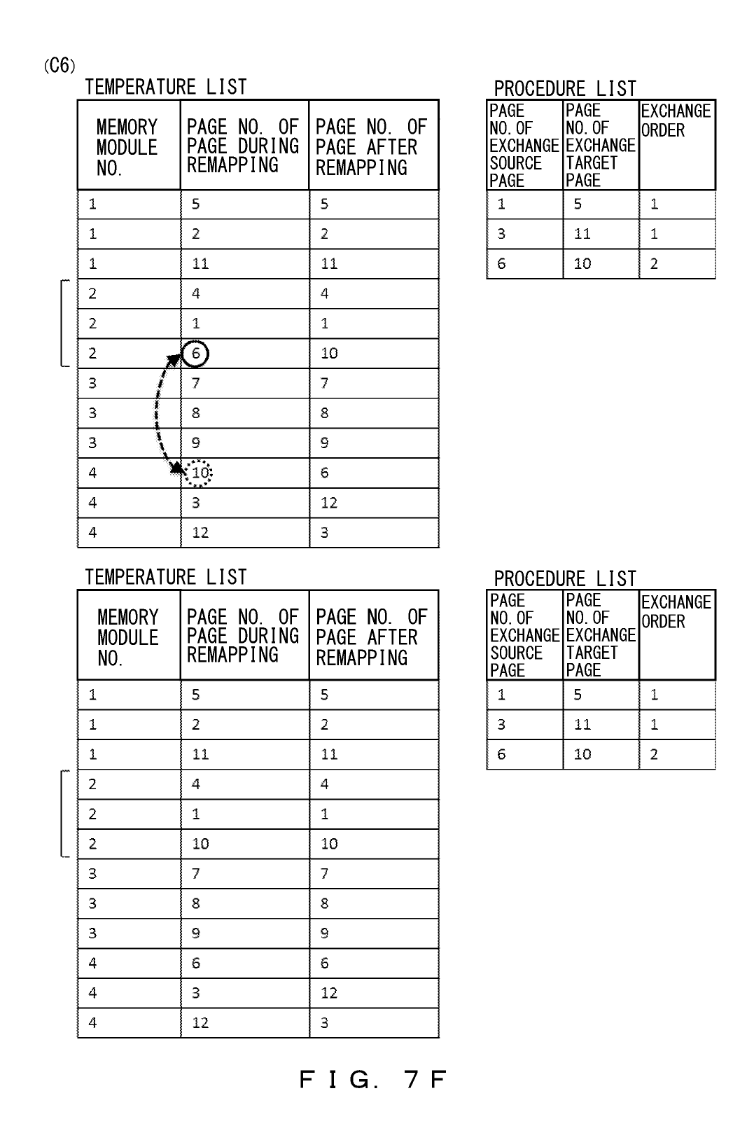

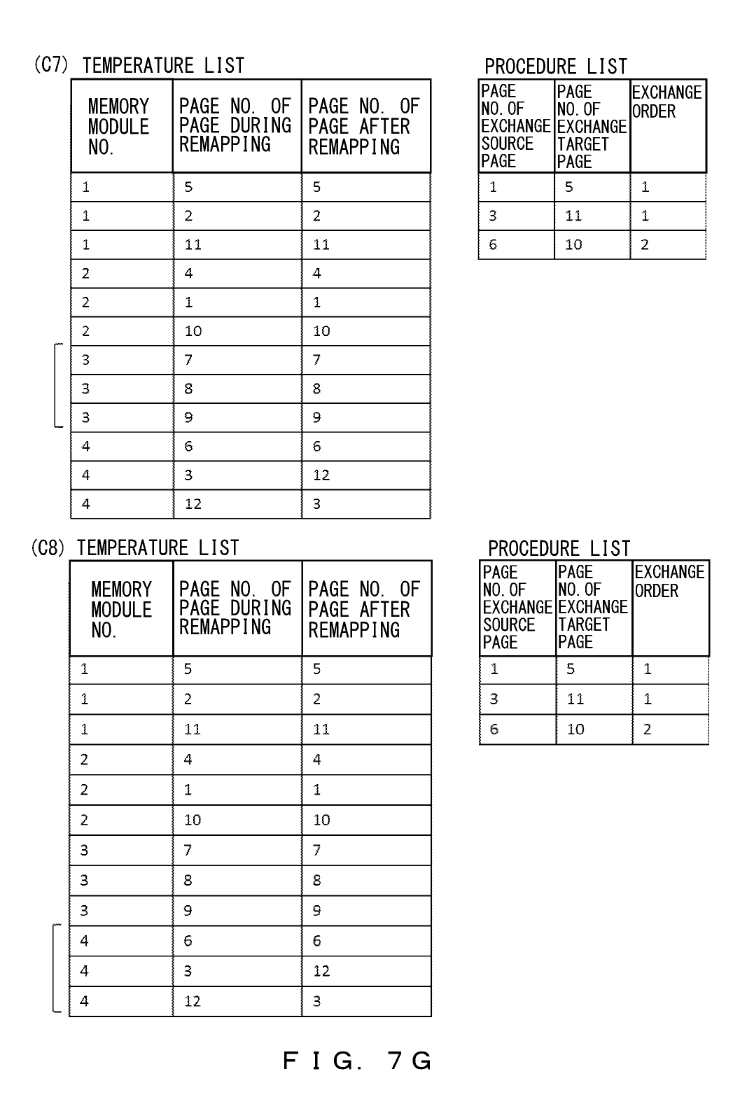

FIGS. 7A to 7G are diagrams for explaining an example of processing of generating a procedure list. If all of the page exchanges according to a temperature list are performed at the same time, an exchange target page for a certain page may be an exchange source page for another page, which may result in a page exchange competition. Thus, the processing unit 115 generates a procedure list and defines an order of page exchange processing. The processing of generating a procedure list is described sequentially below.

(C1) The processing unit 115 selects one memory module from a temperature list. When there exists a page number in common in the categories of the page number of a page during remapping and the page number of a page after remapping in the temperature list with respect to the selected memory module, the processing unit 115 performs an exchange in a page number of a page after remapping so that a page number of a page during remapping and a page number of a page after remapping in a certain entry are the same. Specifically, referring to the temperature list of FIG. 6B, “2” is a page number in common for the memory module 1. Thus, the processing unit 115 exchanges the places of the page number “2” of a page after remapping and the page number “11” of a page after remapping so that a page number of a page during remapping and a page number of a page after remapping in a certain entry are both “2”.

(C2) With respect to the selected memory module, the processing unit 115 moves, to a procedure list, an entry in which there is a change in page number before and after remapping. The procedure list includes categories such as a page number of an exchange source page, a page number of an exchange target page, and an exchange order. A page number of a page during remapping is set in the category of the page number of an exchange source page. A page number of a page after remapping is set in the category of the page number of an exchange target page. The exchange order is an order of page exchange processing. Here, the process of (C2) is the first write into the procedure list, so “1” is set in the category of the exchange order.

(C3) When the page mapping of a virtual memory address in which the page may actually be being accessed is exchanged, the access state of a memory module is also changed, so the processing unit 115 temporarily controls a page exchange of a virtual memory address in the temperature list. Specifically, in order to reflect, in the temperature list, a state in which the mapping for the memory module 1 has been changed, the processing unit 115 exchanges the places of the numbers 1 and 5, and the places of the numbers 3 and 11 in the category of the page number of a page during remapping in the temperature list according to the content of the procedure list. As a result, the page number of a page during remapping in the temperature list represents the state in which the pages for the memory module 1 have been remapped.

(C4) The processing unit 115 selects a next memory module (the memory module 2) from the temperature list. When there exists a page number in common in the categories of the page number of a page during remapping and the page number of a page after remapping in the temperature list with respect to the selected memory module, the processing unit 115 performs an exchange in a page number of a page after remapping so that a page number of a page during remapping and a page number of a page after remapping in a certain entry are the same. Specifically, referring to the temperature list of FIG. 6, “1” is a page number in common for the memory module 2. Thus, the processing unit 115 exchanges the places of the page number “1” of a page after remapping and the page number “10” of a page after remapping so that a page number of a page during remapping and a page number of a page after remapping in a certain entry are both “1”.

(C5) With respect to the selected memory module 2, the processing unit 115 moves, to the procedure list, an entry in which there is a change in page number before and after remapping. Here, the process of (C5) is the second write into the procedure list, so “2” is set in the category of the exchange order.

(C6) In order to reflect, in the temperature list, a state in which the mapping for the memory module 2 has been changed, the processing unit 115 exchanges the places of the numbers 6 and 10 in the category of the page number of a page during remapping in the temperature list according to the content of the procedure list. As a result, the page number of a page during remapping in the temperature list represents the state in which the pages for the memory module 2 have been remapped.

(C7) The processing unit 115 selects a next memory module (the memory module 3) from the temperature list. Each page number in the category of the page number of a page during remapping and each page number in the category of the page number of a page after remapping are the same, and with respect to each page number in common, the page number of a page during remapping and the page number of a page after remapping in the same entry are the same, so the processing unit 115 does not perform page exchange processing for the memory module 3.

(C8) The processing unit 115 selects a next memory module (the memory module 4) from the temperature list. Each page number in the category of the page number of a page during remapping and each page number in the category of the page number of a page after remapping are the same for the memory module 4, so the processing unit 115 does not perform page exchange processing for the memory module 4. The processing unit 115 terminates the processing of generating a procedure list for all of the memory modules.

When the mapping in a virtual memory is exchanged according to a procedure list generated in the processes of (C1) to (C8), the temperatures of memory modules are equalized. A mapping exchange (remapping) in a virtual memory is performed by the memory management unit 207 according to the instruction given by the processing unit 115.

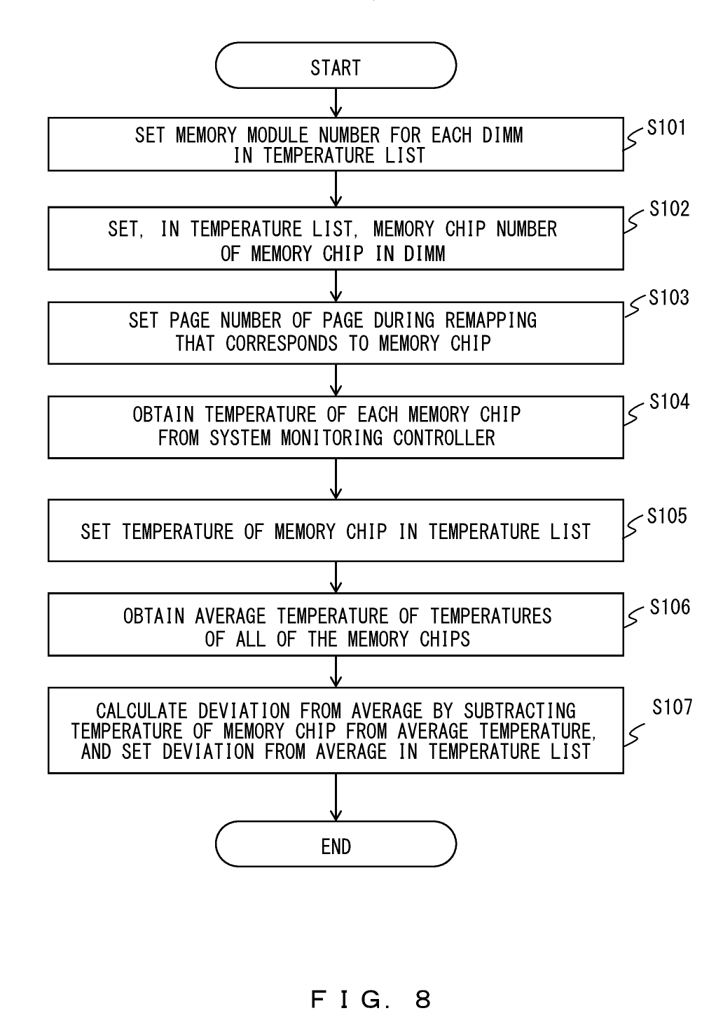

FIG. 8 is a flowchart that illustrates an example (Part 1) of processing of generating a temperature list. The flowchart of FIG. 8 illustrates the processes of (A1) to (A4) described in FIG. 5. The processing unit 115 sets a memory module number corresponding to a DIMM in the temperature list (Step S101). It is assumed that the VMM holds information on a physical resource such as a memory module in order to create a virtual environment. The processing unit 115 sets a memory chip number of a memory chip provided in each memory module in the temperature list (Step S102). The processing unit 115 sets, in the temperature list, a page number of a page during remapping that is mapped to each memory chip (Step S103). The processing unit 115 obtains information that is a temperature of each memory chip from the system monitoring controller 205 (Step S104). The processing unit 115 sets the obtained temperature of each memory chip in the category of the memory chip temperature in the temperature list (Step S105). The processing unit 115 calculates an average temperature of the obtained temperatures of all of the memory chips (Step S106). The processing unit 115 calculates a deviation of the temperature of each of the memory chips from the average temperature, and sets the calculated deviation in the temperature list (Step S107).

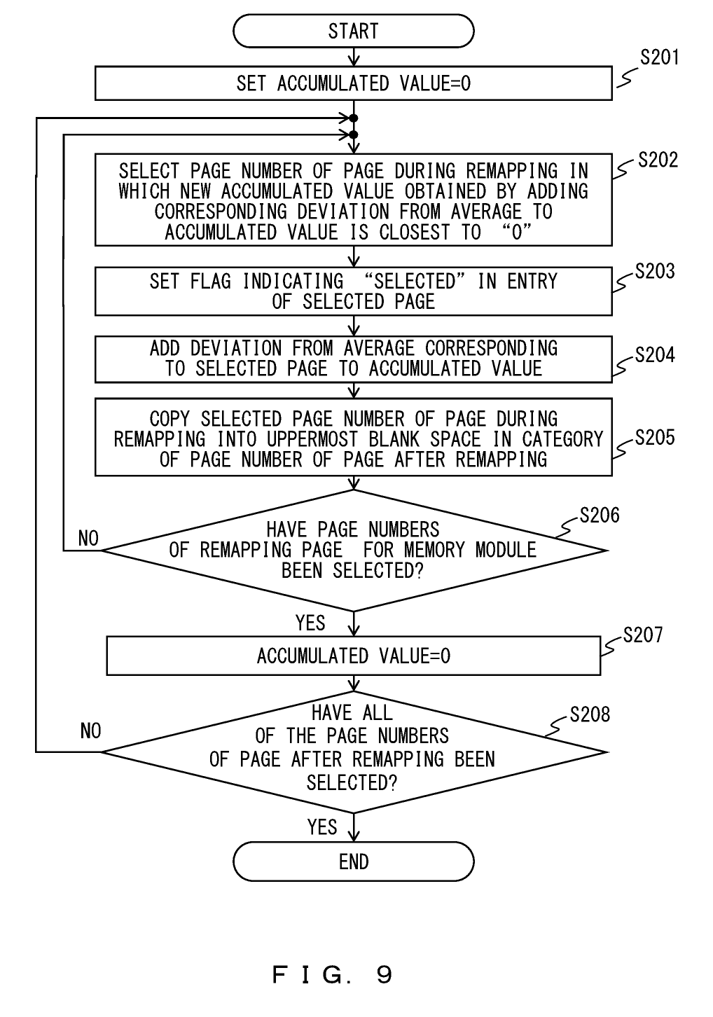

FIG. 9 is a flowchart that illustrates the example (Part 2) of the processing of generating a temperature list. The flowchart of FIG. 9 illustrates the processes of (A5) to (A5.10) that are processing of the processing unit 115 selecting a page number of a page assigned to each memory chip after remapping is performed. First, the processing unit 115 sets an accumulated value to 0 (Step S201). The processing unit 115 selects a page number of a page during remapping in which a value obtained by adding the corresponding deviation from an average to the accumulated value is closest to “0” (Step S202). The processing unit 115 sets, in the category of the flag indicating “selected” in the temperature list, information indicating that the selected page number of a page during remapping has been selected (Step S203). The processing unit 115 adds the deviation corresponding to the selected page to the accumulated value (Step S204). The processing unit 115 sets the selected page number of a page during remapping in an uppermost blank space in the category of the page number of a page after remapping in the temperature list (Step S205). The processing unit 115 determines whether pages that correspond to the number of memory chips provided in a memory module have been selected (Step S206). When the pages that correspond to the number of memory chips provided in the memory module have not been selected (NO in Step S206), the processing unit 115 repeats the processes of and after Step S202.

When the pages that correspond to the number of memory chips provided in the memory module have been selected (YES in Step S206), the processing unit 115 sets the accumulated value to 0 (Step S207). The processing unit 115 determines whether all of the page numbers have been selected (Step S208). When all of the page numbers have not been selected (NO in Step S208), the processing unit 115 repeats the processes of and after Step S202. When all of the page numbers have been selected (YES in Step S208), the processing unit 115 terminates the processing performed when a temperature list is generated.

As described above, it is possible to select a combination of pages in which the temperature of each memory module is equalized by selecting a combination of three page numbers of a page during remapping in which the sum of the corresponding three deviations is close to 0.

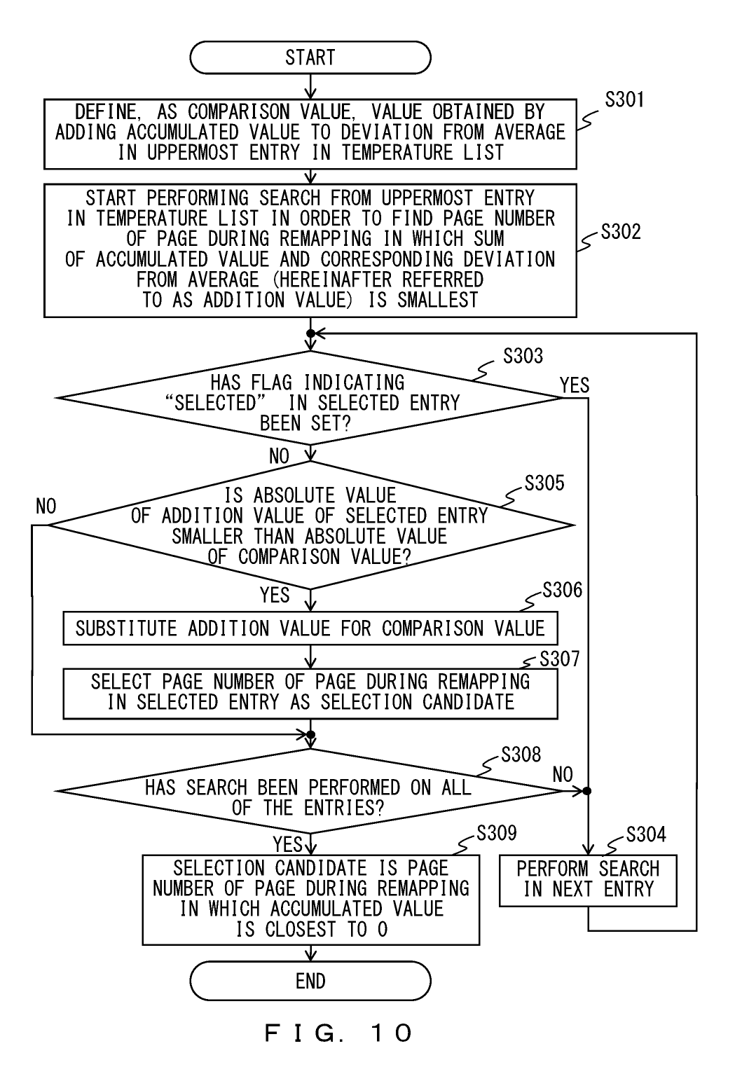

FIG. 10 is a flowchart that illustrates the example (Part 3) of the processing of generating a temperature list. The flowchart of FIG. 10 illustrates the process of Step S202 of FIG. 9 in detail. The processing unit 115 sets, to be a comparison value, a value obtained by adding the deviation from an average in an uppermost entry in the temperature list to the accumulated value (Step S301). In order to find a page number of a page during remapping in which the sum of the accumulated value and the corresponding deviation from an average (hereinafter referred to as an addition value) is smallest, the processing unit 115 selects the uppermost entry and performs a search in the uppermost entry (Step S302). The processing unit 115 determines whether a setting has been made in the category of the flag indicating “selected” of the selected entry (Step S303). When the setting has been made in the category of the flag indicating “selected” in the selected entry (YES in Step S303), the processing unit 115 selects a next entry and performs a search in the next entry (Step S304).

When the setting has not been made in the category of the flag indicating “selected” in the selected entry (NO in Step S303), the processing unit 115 determines whether an absolute value of the addition value of the selected entry is smaller than an absolute value of the comparison value (YES in Step S305). When the absolute value of the addition value of the selected entry is smaller than the absolute value of the comparison value (YES in Step S305), the processing unit 115 substitutes the addition value for the comparison value (Step S306). The processing unit 115 selects the page number of a page during remapping in the selected entry as a selection candidate (Step S307). After the process of Step S307, or when the absolute value of the addition value of the selected entry is larger than the absolute value of the comparison value (NO in Step S305), the processing unit 115 determines whether a search has been performed in all of the entries (Step S308). When a search has not been performed in all of the entries (NO in Step S308), the processing unit 115 repeats the processes of and after Step S304. When a search has been performed in all of the entries (YES in Step S308), the processing unit 115 finally determines that the page number of a page during remapping of the selected entry that is selected as a selection candidate in the process of Step S307 is a page number of a page during remapping in which the accumulated value is closest to 0 (Step S309).

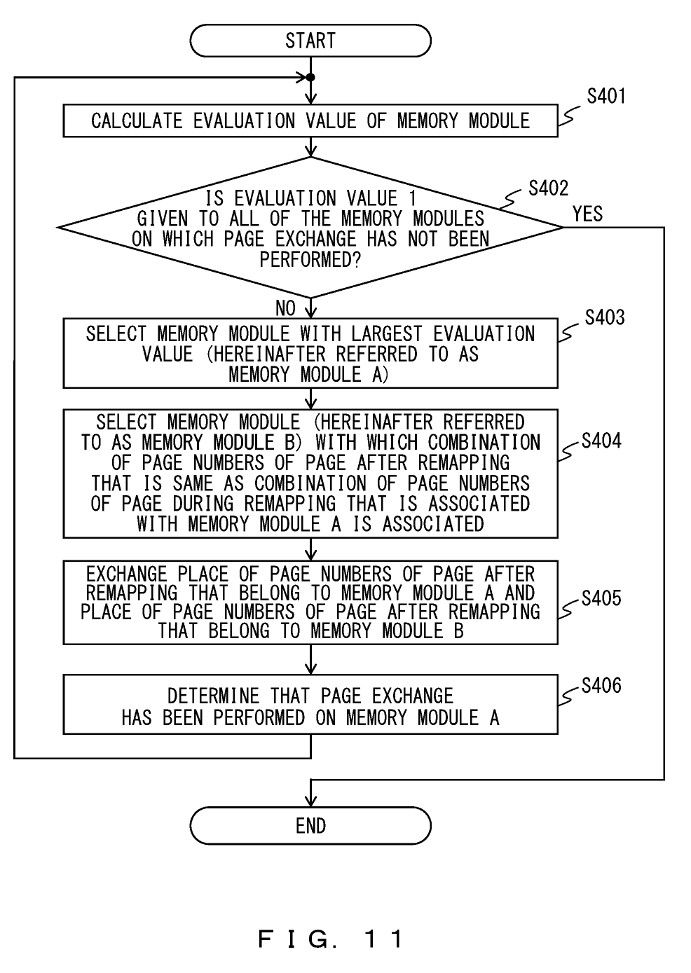

FIG. 11 is a flowchart that illustrates the example of the processing of optimizing a temperature list. The processing of optimizing a temperature list (the processing for reducing the number of page exchanges) is hereinafter also referred to as an organization of a temperature list. The flowchart of FIG. 11 illustrates the processes of (B1) to (B3) of FIGS. 6A and 6B) in detail.

The processing unit 115 evaluates a page number of a page during remapping that is associated with each memory module in the temperature list (Step S401). The processing unit 115 determines whether the evaluation value 1 is given to all of the memory modules, in the temperature list, on which optimization processing has not been performed (on which a page exchange has not been performed) (Step S402). When the evaluation value 1 is given to all of the memory modules, in the temperature list, on which optimization processing has not been performed (YES in Step S402), the processing unit 115 terminates the processing. When the evaluation value 1 is not given to all of the memory modules, in the temperature list, on which optimization processing has not been performed (NO in Step S402), the processing unit 115 selects a memory module with a largest evaluation value (hereinafter referred to as a memory module A) (Step S403). The processing unit 115 selects a memory module (hereinafter referred to as a memory module B) with which a combination of page numbers of a page after remapping that is the same as a combination of page numbers of a page during remapping that is associated with the memory module A is associated (Step S404). The processing unit 115 exchanges the place of the page numbers of a page after remapping that belong to the memory module A and the place of the page numbers of a page after remapping that belong to the memory module B (Step S405). The processing unit 115 determines that a page exchange has been performed on the memory module A (Step S406). When the process of Step S406 has been terminated, the processing unit 115 repeats the processes of and after Step S401.

As described above, when there is a combination of pages after remapping that is associated with a certain memory module and is similar to a combination of pages during remapping that was associated with another memory module, it is preferable that the combination of pages after remapping be associated with the another memory module because it is possible to reduce the number of page exchanges.

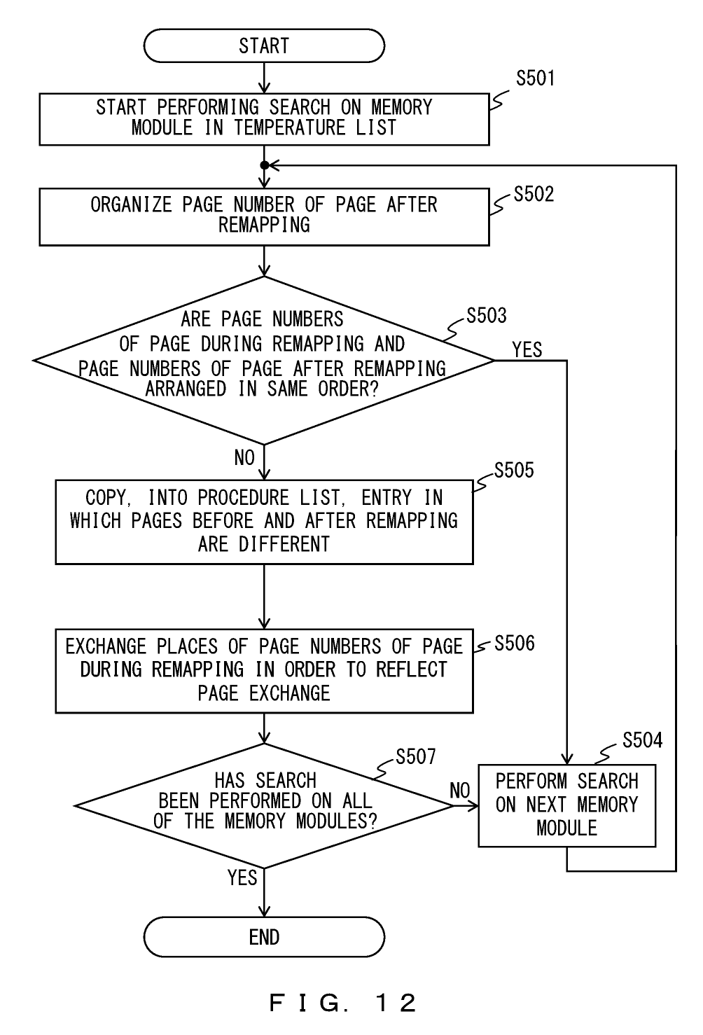

FIG. 12 is a flowchart that illustrates the example of the processing of generating a procedure list. The flowchart of FIG. 12 illustrates the processes of (C1) to (C8) of FIG. 7. The processing unit 115 selects one memory module from a temperature list (Step S501). When there exists a page number in common in the categories of the page number of a page during remapping and the page number of a page after remapping in the temperature list with respect to the selected memory module, the processing unit 115 performs an exchange in a page number of a page after remapping so that a page number of a page during remapping and a page number of a page after remapping in a certain entry are the same (Step S502). The processing unit 115 determines whether a page number of a page during remapping and a page number of a page after remapping in a certain entry are the same with respect to the selected memory module (Step S503).

When the page number of a page during remapping and the page number of a page after remapping in the certain entry are the same with respect to the selected memory module (YES in Step S503), the processing unit 115 selects a next memory module (Step S504). When the page number of a page during remapping and the page number of a page after remapping in the certain entry are not the same with respect to the selected memory module (NO in Step S503), the processing unit 115 moves, to a procedure list, an entry in which there is a change in page number before and after remapping (Step S505). In order to reflect a page exchange in the temperature list, the processing unit 115 exchanges the places of page numbers of a page during remapping (Step S506). The processing unit 115 determines whether the processing has been performed on all of the memory modules (Step S507). When the processing has not been performed on all of the memory modules (NO in Step S507), the processing unit 115 repeats the processes of and after Step S504. When the processing has been performed on all of the memory modules (YES in Step S507), the processing unit 115 terminates the processing of generating a procedure list.

When the mapping in a virtual memory is exchanged according to the generated procedure list, the temperatures of memory modules are equalized. A mapping exchange (remapping) in a virtual memory is performed by the memory management unit 207 according to the instruction given by the processing unit 115.

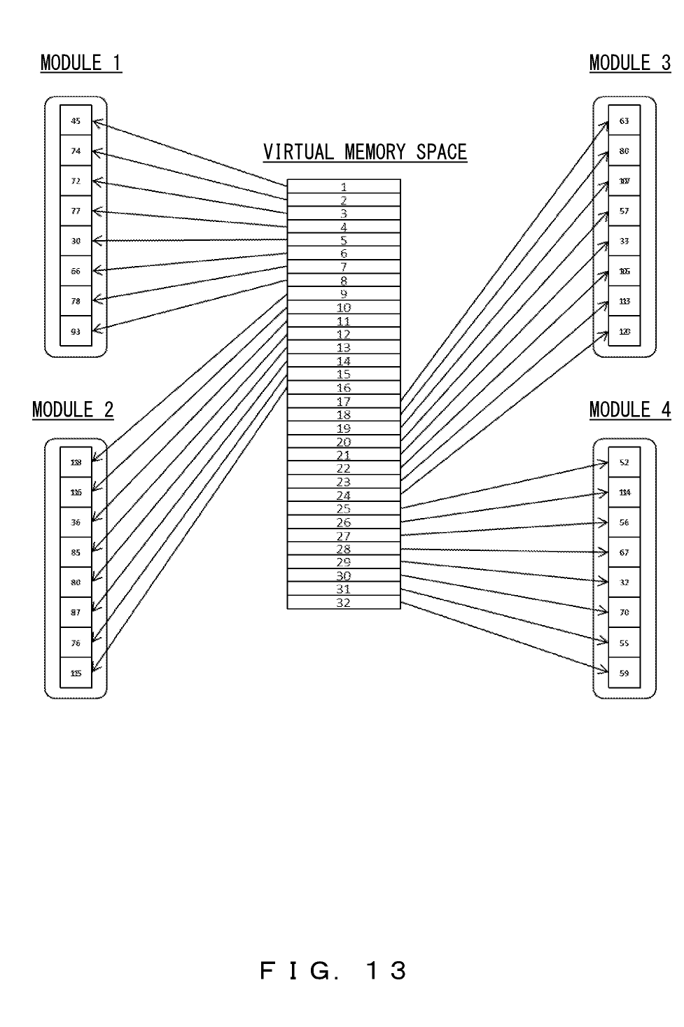

FIG. 13 illustrates a second example of memory modules before remapping is performed. A memory module 1 of FIG. 13 includes memory chips that respectively have memory chip numbers 1 to 8. The memory chip, for the memory module 1, which has a memory chip number 1 is associated with a page number 1 of a virtual memory, and the temperature of this memory chip is 45 degrees. The memory chip, for the memory module 1, which has a memory chip number 2 is associated with a page number 2 of the virtual memory, and the temperature of this memory chip is 74 degrees. The memory chip, for the memory module 1, which has a memory chip number 3 is associated with a page number 3 of the virtual memory, and the temperature of this memory chip is 72 degrees. The memory chip, for the memory module 1, which has a memory chip number 4 is associated with a page number 4 of the virtual memory, and the temperature of this memory chip is 77 degrees. The memory chip, for the memory module 1, which has a memory chip number 5 is associated with a page number 5 of the virtual memory, and the temperature of this memory chip is 30 degrees. The memory chip, for the memory module 1, which has a memory chip number 6 is associated with a page number 6 of the virtual memory, and the temperature of this memory chip is 66 degrees. The memory chip, for the memory module 1, which has a memory chip number 7 is associated with a page number 7 of the virtual memory, and the temperature of this memory chip is 78 degrees. The memory chip, for the memory module 1, which has a memory chip number 8 is associated with a page number 8 of the virtual memory, and the temperature of this memory chip is 93 degrees. The average of the temperatures of the memory chips provided in the memory module 1 is about 66.8 degrees.

A memory module 2 of FIG. 13 includes memory chips that respectively have memory chip numbers 1 to 8. The memory chip, for the memory module 2, which has a memory chip number 1 is associated with a page number 9 of the virtual memory, and the temperature of this memory chip is 118 degrees. The memory chip, for the memory module 2, which has a memory chip number 2 is associated with a page number 10 of the virtual memory, and the temperature of this memory chip is 116 degrees. The memory chip, for the memory module 2, which has a memory chip number 3 is associated with a page number 11 of the virtual memory, and the temperature of this memory chip is 36 degrees. The memory chip, for the memory module 2, which has a memory chip number 4 is associated with a page number 12 of the virtual memory, and the temperature of this memory chip is 85 degrees. The memory chip, for the memory module 2, which has a memory chip number 5 is associated with a page number 13 of the virtual memory, and the temperature of this memory chip is 80 degrees. The memory chip, for the memory module 2, which has a memory chip number 6 is associated with a page number 14 of the virtual memory, and the temperature of this memory chip is 87 degrees. The memory chip, for the memory module 2, which has a memory chip number 7 is associated with a page number 15 of the virtual memory, and the temperature of this memory chip is 76 degrees. The memory chip, for the memory module 2, which has a memory chip number 8 is associated with a page number 16 of the virtual memory, and the temperature of this memory chip is 115 degrees. The average of temperatures of the memory chips provided in the memory module 2 is about 89.1 degrees.

A memory module 3 of FIG. 13 includes memory chips that respectively have memory chip numbers 1 to 8. The memory chip, for the memory module 3, which has a memory chip number 1 is associated with a page number 17 of the virtual memory, and the temperature of this memory chip is 63 degrees. The memory chip, for the memory module 3, which has a memory chip number 2 is associated with a page number 18 of the virtual memory, and the temperature of this memory chip is 80 degrees. The memory chip, for the memory module 3, which has a memory chip number 3 is associated with a page number 19 of the virtual memory, and the temperature of this memory chip is 107 degrees. The memory chip, for the memory module 3, which has a memory chip number 4 is associated with a page number 20 of the virtual memory, and the temperature of this memory chip is 57 degrees. The memory chip, for the memory module 3, which has a memory chip number 5 is associated with a page number 21 of the virtual memory, and the temperature of this memory chip is 33 degrees. The memory chip, for the memory module 3, which has a memory chip number 6 is associated with a page number 22 of the virtual memory, and the temperature of this memory chip is 105 degrees. The memory chip, for the memory module 3, which has a memory chip number 7 is associated with a page number 23 of the virtual memory, and the temperature of this memory chip is 113 degrees. The memory chip, for the memory module 3, which has a memory chip number 8 is associated with a page number 24 of the virtual memory, and the temperature of this memory chip is 120 degrees. The average of temperatures of the memory chips provided in the memory module 3 is about 84.8 degrees.

A memory module 4 of FIG. 13 includes memory chips that respectively have memory chip numbers 1 to 8. The memory chip, for the memory module 4, which has a memory chip number 1 is associated with a page number 25 of the virtual memory, and the temperature of this memory chip is 52 degrees. The memory chip, for the memory module 4, which has a memory chip number 2 is associated with a page number 26 of the virtual memory, and the temperature of this memory chip is 114 degrees. The memory chip, for the memory module 4, which has a memory chip number 3 is associated with a page number 27 of the virtual memory, and the temperature of this memory chip is 56 degrees. The memory chip, for the memory module 4, which has a memory chip number 4 is associated with a page number 28 of the virtual memory, and the temperature of this memory chip is 67 degrees. The memory chip, for the memory module 4, which has a memory chip number 5 is associated with a page number 29 of the virtual memory, and the temperature of this memory chip is 32 degrees. The memory chip, for the memory module 4, which has a memory chip number 6 is associated with a page number 30 of the virtual memory, and the temperature of this memory chip is 70 degrees. The memory chip, for the memory module 4, which has a memory chip number 7 is associated with a page number 31 of the virtual memory, and the temperature of this memory chip is 55 degrees. The memory chip, for the memory module 4, which has a memory chip number 8 is associated with a page number 32 of the virtual memory, and the temperature of this memory chip is 59 degrees. The average of temperatures of the memory chips provided in the memory module 4 is about 63.1 degrees.

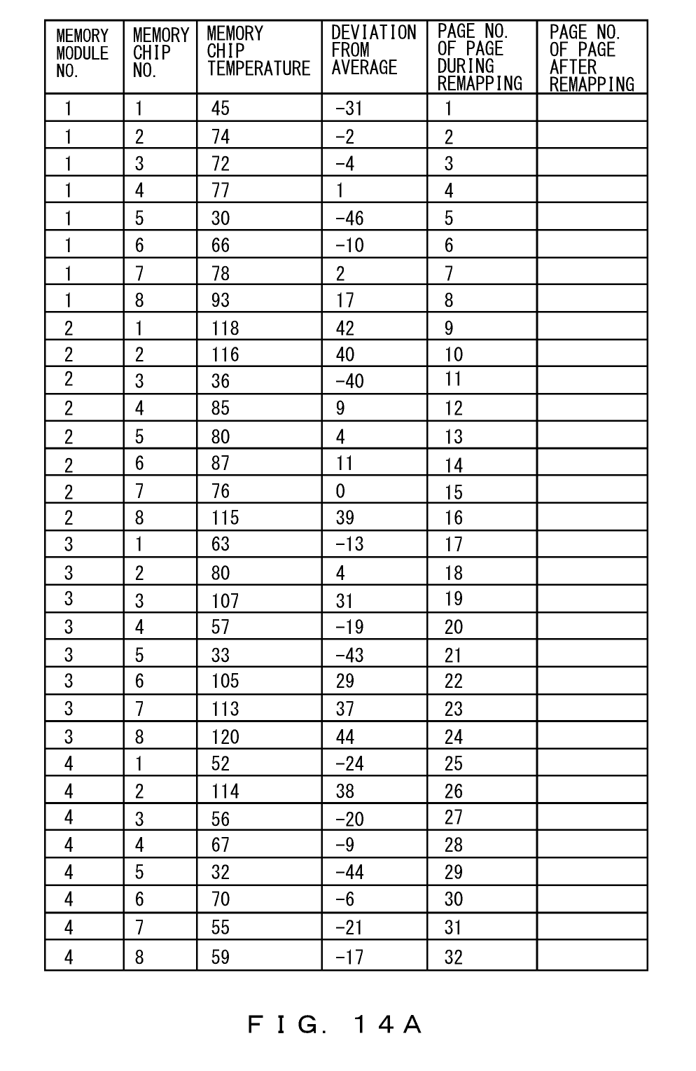

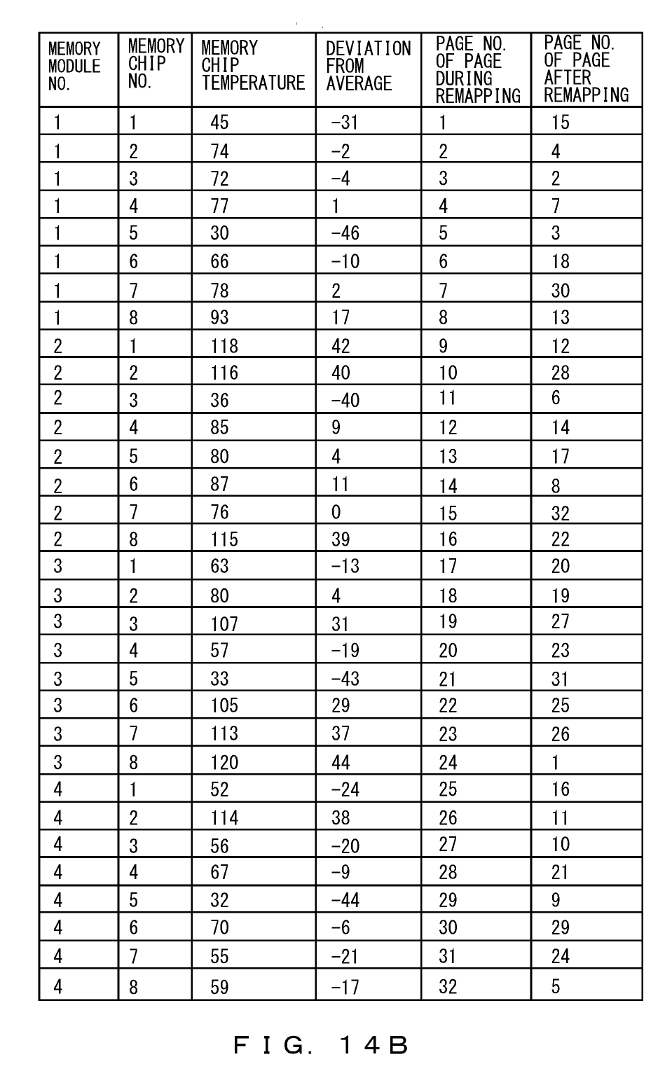

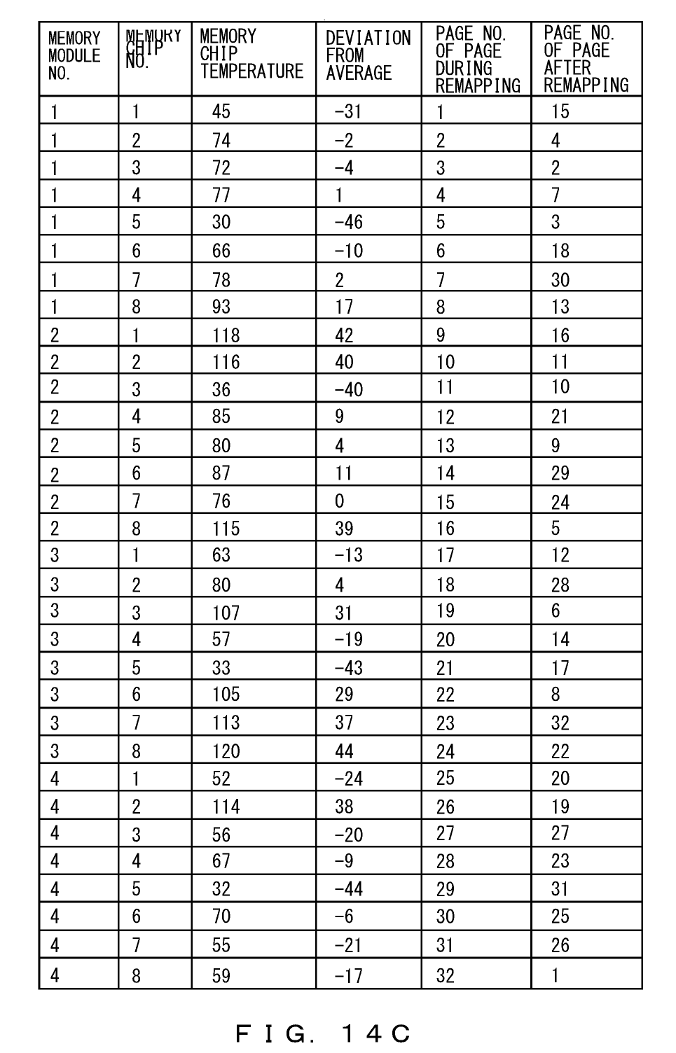

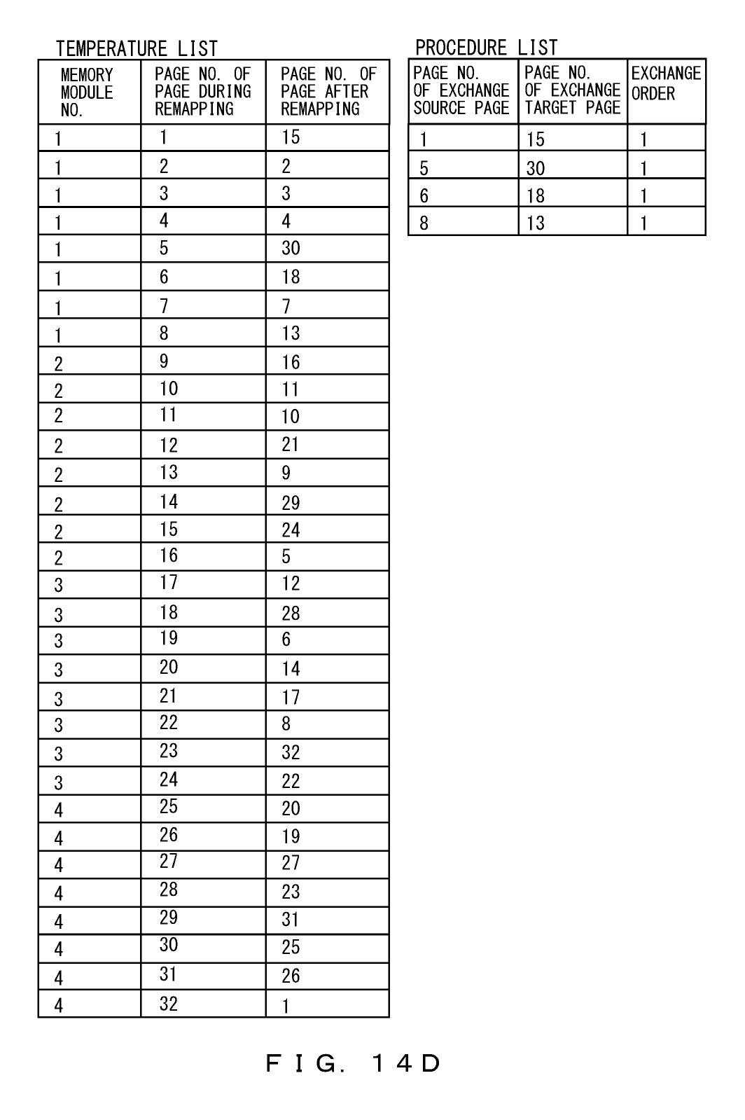

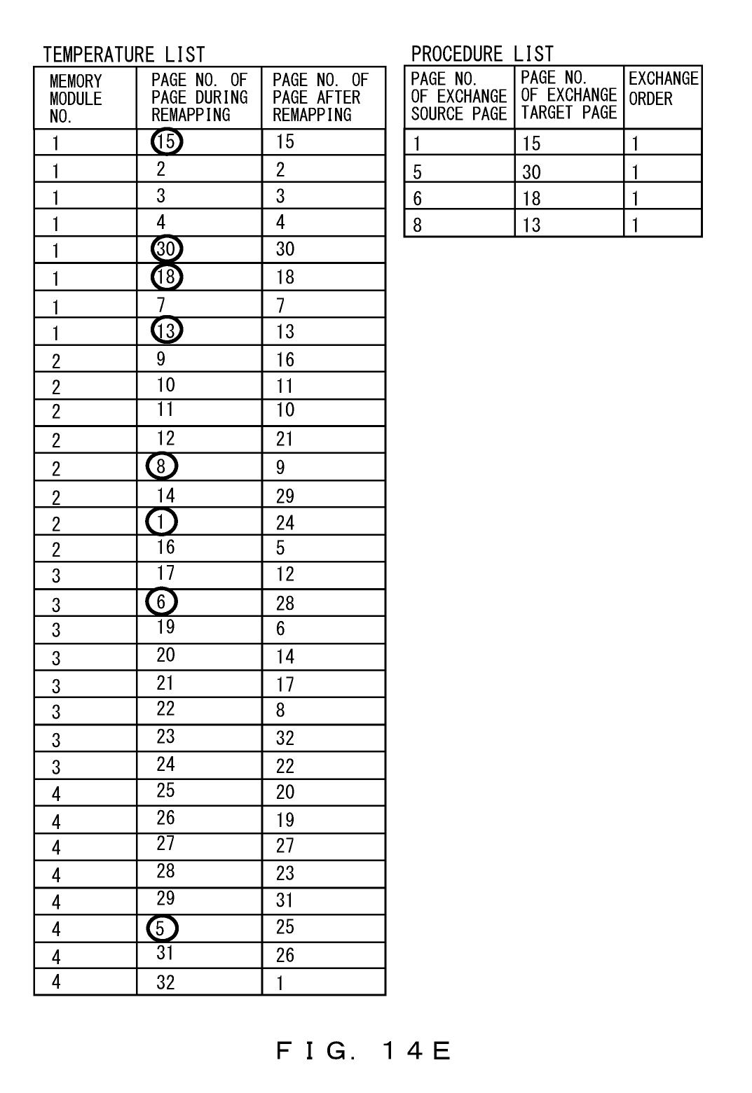

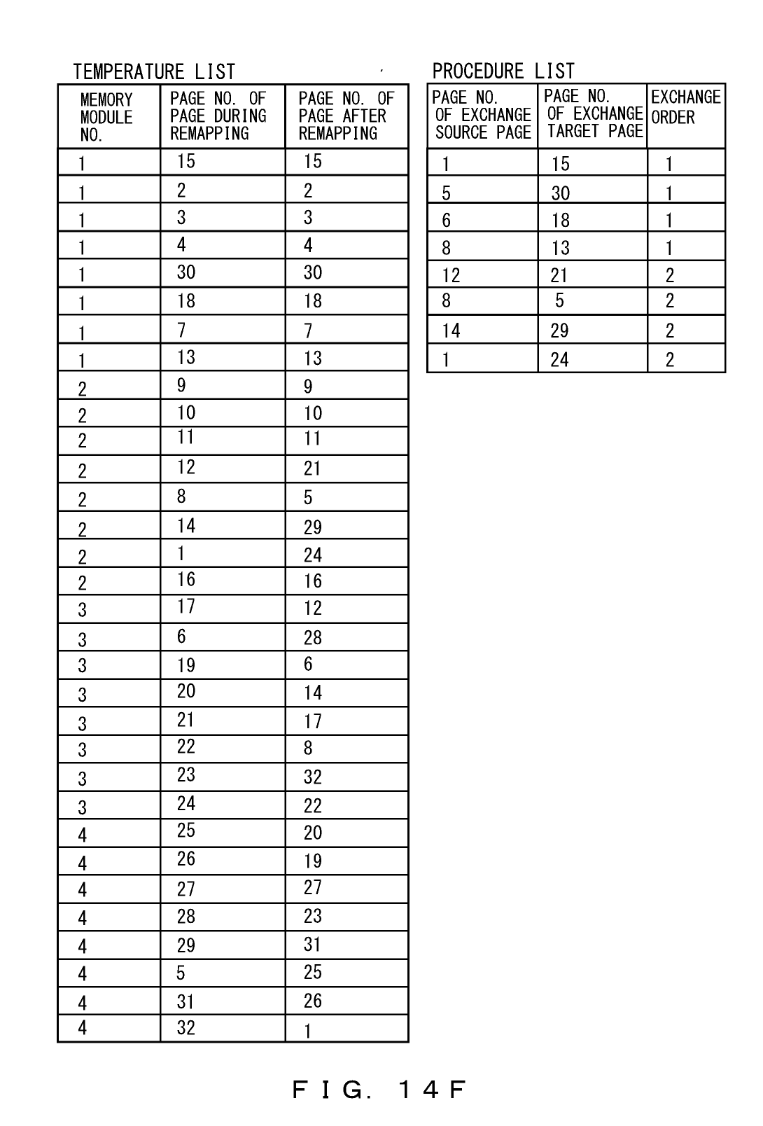

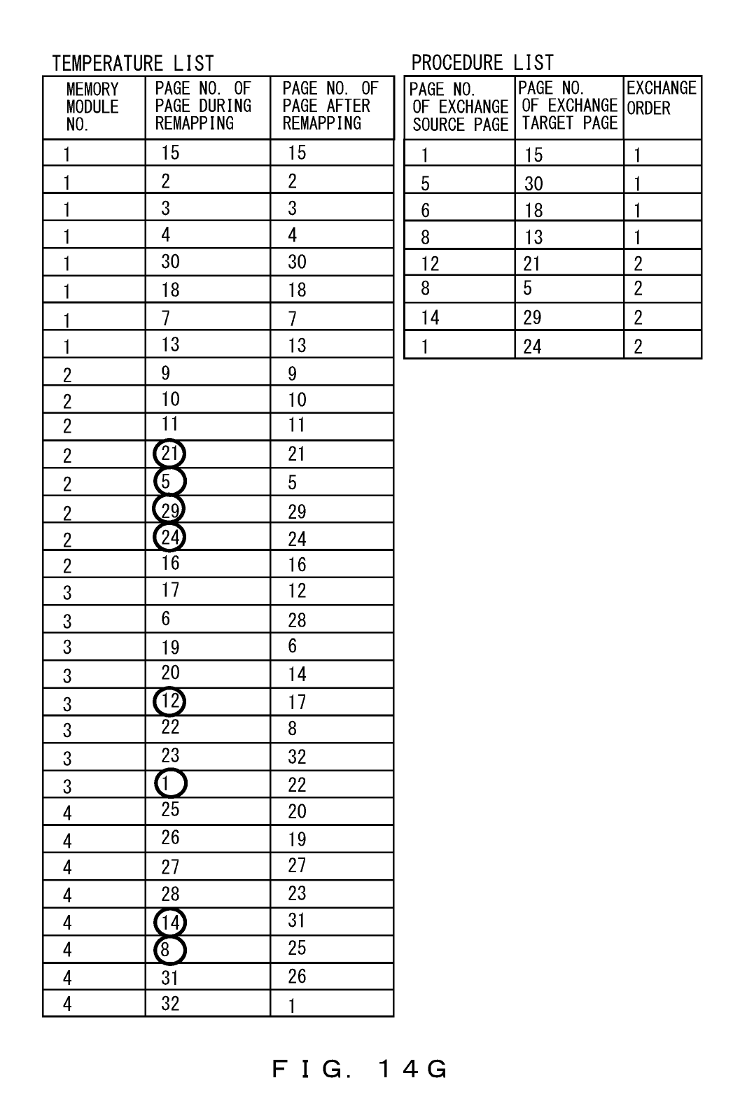

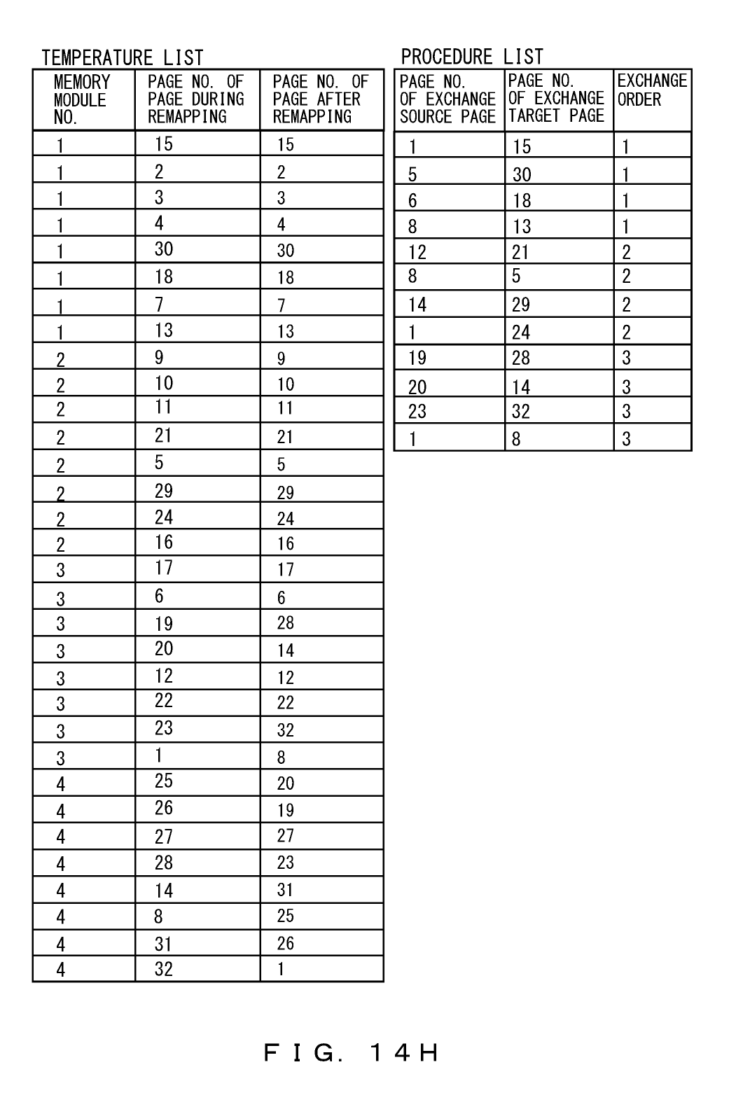

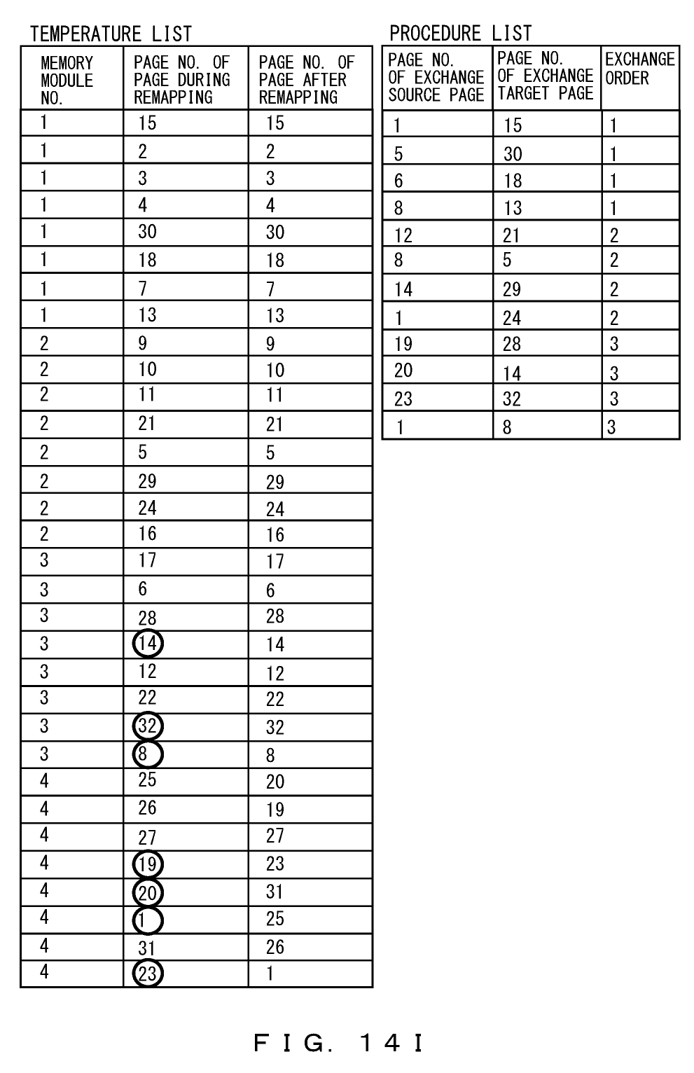

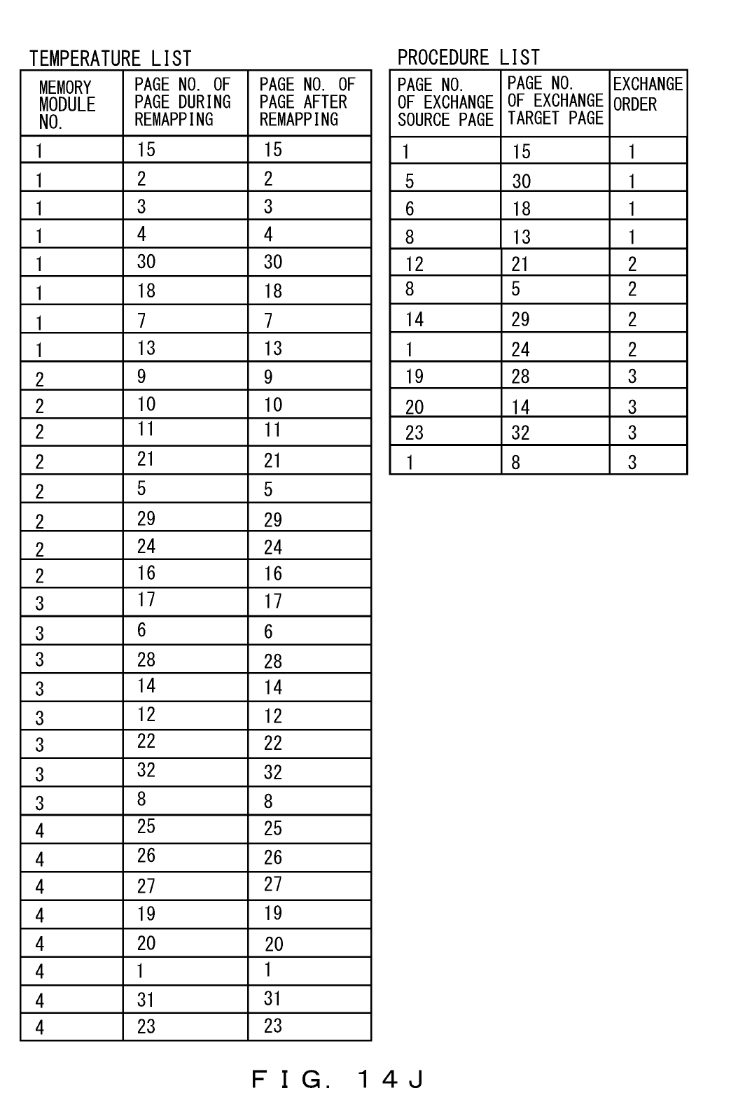

FIGS. 14A to 14J are diagrams for explaining a second example of the processing of generating a temperature list. FIG. 14A illustrates an example of a temperature list that is generated in the processes of Step S101 to Step S107 of FIG. 8 when remapping processing is started with respect to the memory modules illustrated in FIG. 13. Specifically, the processing unit 115 sets a memory module number, a memory chip number, and a page number of a page during remapping in a temperature list. The processing unit 115 obtains information that is a temperature of each memory chip from the system monitoring controller 205. The processing unit 115 sets the obtained temperature of each memory chip in the category of the memory chip temperature in the temperature list. The processing unit 115 calculates a deviation of the temperature of each memory chip from an average temperature, and sets the calculated deviation in the temperature list.

FIG. 14B illustrates an example of processing of selecting a page number of a page after remapping by performing the processes of Step S201 to Step S208 of FIG. 9. Specifically, the processing unit 115 performs processing of selecting a page number of a page during remapping that is assigned to each memory chip after remapping is performed. The number of memory chips provided in each memory module is eight, so the processing unit 115 selects a combination of eight page numbers of a page during remapping in which the sum of deviations from an average that correspond to the eight page numbers of a page during remapping is close to 0.

As a result, the page numbers “15, 4, 2, 7, 3, 18, 30, and 13” of a page during remapping are set in the category of the page number of a page after remapping for the memory module 1. The sum of deviations from an average that correspond to the set page numbers of a page after remapping for the memory module 1 is “−1”. The page numbers “12, 28, 6, 14, 17, 8, 32, and 22” of a page during remapping are set in the category of the page number of a page after remapping for the memory module 2. The sum of deviations from an average that correspond to the set page numbers of a page after remapping for the memory module 2 is “17”. The page numbers “20, 19, 27, 23, 31, 25, 26, and 1” of a page during remapping are set in the category of the page number of a page after remapping for the memory module 3. The sum of deviations from an average that correspond to the set page numbers of a page after remapping for the memory module 3 is “−19”. The page numbers “16, 11, 10, 21, 9, 29, 24, and 5” of a page during remapping are set in the category of the page number of a page after remapping for the memory module 4. The sum of deviations from an average that correspond to the set page numbers of a page after remapping for the memory module 4 is “−8”.

FIG. 14C illustrates an example of the processing for reducing the number of page exchanges in the temperature list by performing the processes of Step S401 to Step S406 of FIG. 11. Specifically, first, the processing unit 115 evaluates a page number of a page after remapping for each memory module.

The category of the page number of a page after remapping for the memory module 1 includes four page numbers 2, 3, 4, and 7 that are the page numbers of a page during remapping for the memory module 1. Thus, the processing unit 115 evaluates the page number of a page after remapping for the memory module 1 and determines that its evaluation value is “4”.

The category of the page number of a page after remapping for the memory module 2 includes two page numbers 6 and 8 that are the page numbers of a page during remapping for the memory module 1. The category of the page number of a page after remapping for memory module 2 includes two page numbers 12 and 14 that are the page numbers of a page during remapping for the memory module 2. The category of the page number of a page after remapping for memory module 2 includes two page numbers 17 and 22 that are the page numbers of a page during remapping for the memory module 3. The category of the page number of a page after remapping for memory module 2 includes two page numbers 28 and 32 that are the page numbers of a page during remapping for the memory module 4. Thus, the processing unit 115 evaluates the page number of a page after remapping for the memory module 2 and determines that its evaluation value is “2”.

The category of the page number of a page after remapping for the memory module 3 includes four pages of page numbers 25, 26, 27, and 31 that are the page numbers of a page during remapping for the memory module 4. Thus, the processing unit 115 evaluates the page number of a page after remapping for the memory module 3 and determines that its evaluation value is “4”.

The category of the page number of a page after remapping for the memory module 4 includes four pages of page numbers 9, 10, 11, and 16 that are the page numbers of a page during remapping for the memory module 2. Thus, the processing unit 115 evaluates the page number of a page after remapping for the memory module 4 and determines that its evaluation value is “4”.

The processing unit 115 selects the highly evaluated memory module 1 (the process of Step S403). The page numbers 2, 3, 4, and 7 included in the category of the page number of a page after remapping for memory module 1 are the page numbers of pages that originally belonged to the memory module 1. In order to avoid any unneeded page exchanges, the processing unit 115 keeps the page numbers of a page after remapping for the memory module 1 assigned to the memory module 1. The processing unit 115 determines that a page exchange has been performed on the memory module 1.

Next, the processing unit 115 selects the highly evaluated memory module 3. The page numbers 25, 26, 27, and 31 included in the category of the page number of a page after remapping for the memory module 3 are the page numbers of pages that originally belonged to the memory module 4. In order to avoid any unneeded page exchanges, the processing unit 115 exchanges the places of the page numbers of a page after remapping for the memory module 3 and the page numbers of a page after remapping for the memory module 4. The memory module 3 after the exchange (that is, the original memory module 4) is hereinafter referred to as a memory module 3A. The memory module 4 after the exchange (that is, the original memory module 3) is hereinafter referred to as a memory module 4A. The processing unit 115 determines that a page exchange has been performed on the memory module 4A.

The processing unit 115 selects the highly evaluated memory module 3A on which a page exchange has been performed (the original memory module 4). The page numbers 9, 10, 11, and 16 included in the category of the page number of a page after remapping for the memory module 3A are the page numbers of pages that originally belonged to the memory module 2. In order to avoid any unneeded page exchanges, the processing unit 115 exchanges the places of the page numbers of a page after remapping for the memory module 3A and the page numbers of a page after remapping for the memory module 2. The processing unit 115 determines that a page exchange has been performed on the memory module 3A.

As described above, when there is a combination of pages after remapping that is associated with a certain memory module and is similar to a combination of pages during remapping that was associated with another memory module, it is preferable that the combination of pages after remapping be associated with the another memory module because it is possible to reduce the number of page exchanges.

FIG. 14D illustrates an example of the processing of generating a procedure list by performing the processes of Step S501 to Step S505 of FIG. 12 with respect to the memory module 1. Specifically, first, the processing unit 115 selects the memory module 1. The page numbers 2, 3, 4, and 7 included in the category of the page number of a page after remapping for the memory module 1 are the page numbers of pages that originally belonged to the memory module 1. In order to avoid any unneeded page exchanges, the processing unit 115 assigns each of the pages of the page numbers 2, 3, 4, and 7 included in the category of the page number of a page after remapping to the memory chip to which the page was originally assigned. The processing unit 115 moves, to a procedure list, an entry in which there is a change in page number before and after remapping. In the example of FIG. 14D, a pair of the numbers 1 and 15, a pair of the numbers 5 and 30, a pair of the numbers 6 and 18, and a pair of the numbers 8 and 13 are given in the procedure list as a pair of the page number of a page during remapping and the page number of a page after remapping. This processing is the first write into the procedure list, so “1” is given in the category of the exchange order.

FIG. 14E illustrates an example of processing of updating a temperature list by performing the processes of Step S506 and Step S507 of FIG. 12. Specifically, page exchange processing for the memory module 1 that is performed according to the procedure list is reflected in the temperature list. Thus, the processing unit 115 exchanges the places of the page numbers 1 and 15, the places of the page numbers 5 and 30, the places of the page numbers 6 and 18, and the places of the page numbers 8 and 13 in the category of the page number of a page during remapping in the temperature list.

FIG. 14F illustrates an example of the processing of generating a procedure list by performing the processes of Step S501 to Step S505 of FIG. 12 with respect to the memory module 2. Specifically, first, the processing unit 115 selects the memory module 2. The page numbers 9, 10, 11, and 16 included in the category of the page number of a page after remapping for the memory module 2 are the page numbers of pages that originally belonged to the memory module 2. In order to avoid any unneeded page exchanges, the processing unit 115 assigns each of the pages of the page numbers 9, 10, 11, and 16 included in the category of the page number of a page after remapping to the memory chip to which the page was originally assigned. The processing unit 115 moves, to a procedure list, an entry in which there is a change in page number before and after remapping. In the example of FIG. 14F, a pair of the numbers 12 and 21, a pair of the numbers 8 and 5, a pair of the numbers 14 and 29, and a pair of the numbers 1 and 24 are given in the procedure list as a pair of the page number of a page during remapping and the page number of a page after remapping. This processing is the second write into the procedure list, so “2” is given in the category of the exchange order.

FIG. 14G illustrates an example of processing of updating a temperature list by performing the processes of Step S506 and Step S507 of FIG. 12. Specifically, page exchange processing for the memory module 2 that is performed according to the procedure list is reflected in the temperature list. Thus, the processing unit 115 exchanges the places of the page numbers 12 and 21, the places of the page numbers 8 and 5, the places of the page numbers 14 and 29, and the places of the page numbers 1 and 24 in the category of the page number of a page during remapping in the temperature list.

FIG. 14H illustrates an example of the processing of generating a procedure list by performing the processes of Step S501 to Step S505 of FIG. 12 with respect to the memory module 3. Specifically, first, the processing unit 115 selects the memory module 3. The page numbers 17, 6, 12, and 22 included in the category of the page number of a page after remapping for the memory module 3 are the page numbers of pages that originally belonged to the memory module 3. In order to avoid any unneeded page exchanges, the processing unit 115 assigns each of the pages of the page numbers 17, 6, 12, and 22 included in the category of the page number of a page after remapping to the memory chip to which the page was originally assigned. The processing unit 115 moves, to a procedure list, an entry in which there is a change in page number before and after remapping. In the example of FIG. 14H, a pair of the numbers 19 and 28, a pair of the numbers 20 and 14, a pair of the numbers 23 and 32, and a pair of the numbers 1 and 8 are given in the procedure list as a pair of the page number of a page during remapping and the page number of a page after remapping. This processing is the third write into the procedure list, so “3” is given in the category of the exchange order.

FIG. 14I illustrates an example of processing of updating a temperature list by performing the processes of Step S506 and Step S507 of FIG. 12. Specifically, page exchange processing for the memory module 3 that is performed according to the procedure list is reflected in the temperature list. Thus, the processing unit 115 exchanges the places of the page numbers 19 and 28, the places of the page numbers 20 and 14, the places of the page numbers 23 and 32, and the places of the page numbers 1 and 8 in the category of the page number of a page during remapping in the temperature list.

FIG. 14J illustrates an example of the processing of generating a procedure list by performing the processes of Step S501 to Step S505 of FIG. 12 with respect to the memory module 4. Specifically, first, the processing unit 115 selects the memory module 4. All of the pages whose page numbers are included in the category of the page number of a page after remapping for the memory module 4 are the same as the pages that originally belonged to the memory module 4. Thus, the processing unit 115 terminates the processing of generating a temperature list and a procedure list.

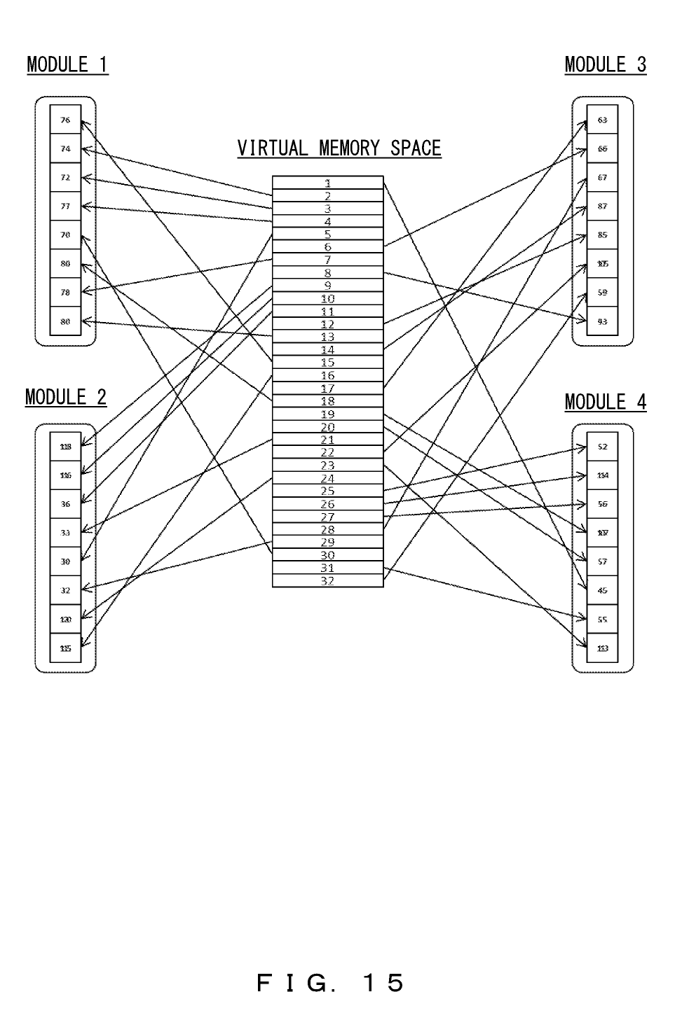

FIG. 15 illustrates the second example of the memory modules after remapping is performed. The memory modules of FIG. 15 are memory modules that have been remapped according to the procedure list generated through FIGS. 14A-14J.

The page number 15 is assigned to the memory chip, for the memory module 1, which has a memory chip number 1. The page number 2 is assigned to the memory chip, for the memory module 1, which has a memory chip number 2. The page number 3 is assigned to the memory chip, for the memory module 1, which has a memory chip number 3. The page number 4 is assigned to the memory chip, for the memory module 1, which has a memory chip number 4. The page number 30 is assigned to the memory chip, for the memory module 1, which has a memory chip number 5. The page number 18 is assigned to the memory chip, for the memory module 1, which has a memory chip number 6. The page number 7 is assigned to the memory chip, for the memory module 1, which has a memory chip number 7. The page number 13 is assigned to the memory chip, for the memory module 1, which has a memory chip number 8. As a result, the average of the temperatures of the memory chips provided in the memory module 1 is 75.9 degrees.

The page number 9 is assigned to the memory chip, for the memory module 2, which has a memory chip number 1. The page number 10 is assigned to the memory chip, for the memory module 2, which has a memory chip number 2. The page number 11 is assigned to the memory chip, for the memory module 2, which has a memory chip number 3. The page number 21 is assigned to the memory chip, for the memory module 2, which has a memory chip number 4. The page number 5 is assigned to the memory chip, for the memory module 2, which has a memory chip number 5. The page number 29 is assigned to the memory chip, for the memory module 2, which has a memory chip number 6. The page number 24 is assigned to the memory chip, for the memory module 2, which has a memory chip number 7. The page number 16 is assigned to the memory chip, for the memory module 2, which has a memory chip number 8. As a result, the average of the temperatures of the memory chips provided in the memory module 2 is 75 degrees.

The page number 17 is assigned to the memory chip, for the memory module 3, which has a memory chip number 1. The page number 6 is assigned to the memory chip, for the memory module 3, which has a memory chip number 2. The page number 28 is assigned to the memory chip, for the memory module 3, which has a memory chip number 3. The page number 14 is assigned to the memory chip, for the memory module 3, which has a memory chip number 4. The page number 12 is assigned to the memory chip, for the memory module 3, which has a memory chip number 5. The page number 22 is assigned to the memory chip, for the memory module 3, which has a memory chip number 6. The page number 32 is assigned to the memory chip, for the memory module 3, which has a memory chip number 7. The page number 8 is assigned to the memory chip, for the memory module 3, which has a memory chip number 8. As a result, the average of the temperatures of the memory chips provided in the memory module 3 is 78.1 degrees.

The page number 25 is assigned to the memory chip, for the memory module 4, which has a memory chip number 1. The page number 26 is assigned to the memory chip, for the memory module 4, which has a memory chip number 2. The page number 27 is assigned to the memory chip, for the memory module 4, which has a memory chip number 3. The page number 19 is assigned to the memory chip, for the memory module 4, which has a memory chip number 4. The page number 20 is assigned to the memory chip, for the memory module 4, which has a memory chip number 5. The page number 1 is assigned to the memory chip, for the memory module 4, which has a memory chip number 6. The page number 31 is assigned to the memory chip, for the memory module 4, which has a memory chip number 7. The page number 23 is assigned to the memory chip, for the memory module 4, which has a memory chip number 8. As a result, the average of the temperatures of the memory chips provided in the memory module 4 is 74.9 degrees.

The temperatures of the memory modules before remapping is performed in FIG. 13 are unequal, from 63 to 89 degrees. On the other hand, the temperatures of the memory modules after remapping is performed in FIG. 15 are almost equal, from 74.9 to 78.1 degrees.

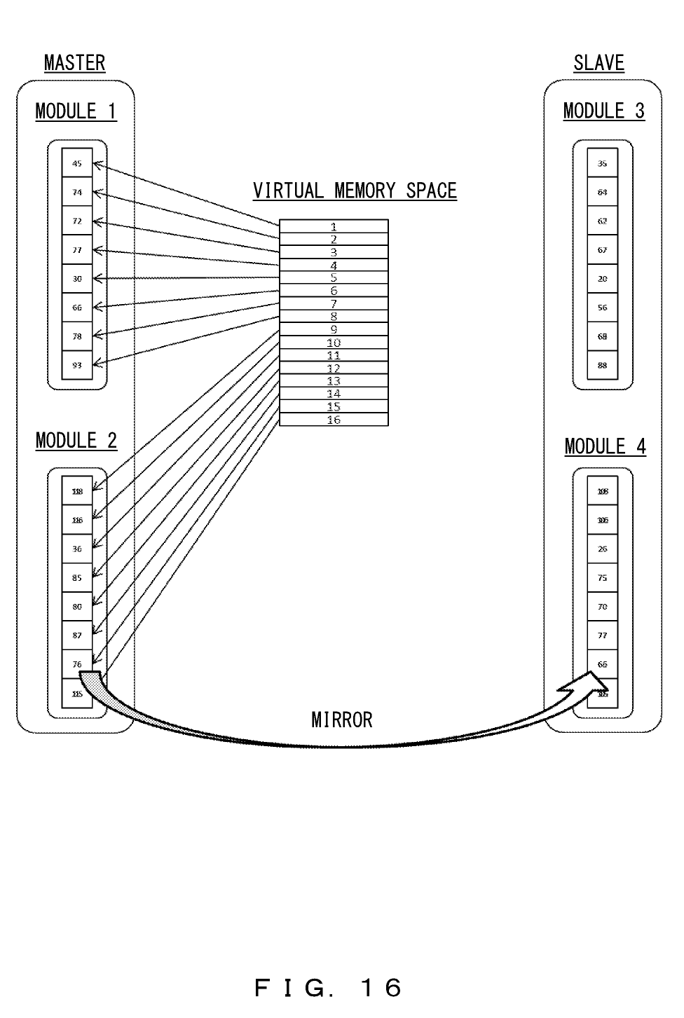

FIG. 16 illustrates an example of memory modules according to a second embodiment. Memory modules 1 and 2 according to the second embodiment are master memory modules (that are used at present). On the other hand, memory modules 3 and 4 are slave memory modules (that are not used at present). A master memory module and a slave memory module are used in pair, and data written into the master memory module is also similarly written into the slave memory module. Data is read only by the master memory module, so the slave memory module is accessed less frequently than the master memory module. The temperature of the slave memory module is lower than that of the master memory module because the slave memory module does not read data and the amount of data access is less than that of the master memory module. The slave memory modules 3 and 4 are used instead of the master memory modules when there occurs a failure in the master memory modules.

For the memory modules according to the second embodiment, remapping processing is performed on the master memory modules 1 and 2 such that the temperatures of the memory modules 1 and 2 are equalized. It is sufficient if the same mapping as that performed on the master memory modules 1 and 2 is performed on the slave memory modules 3 and 4.

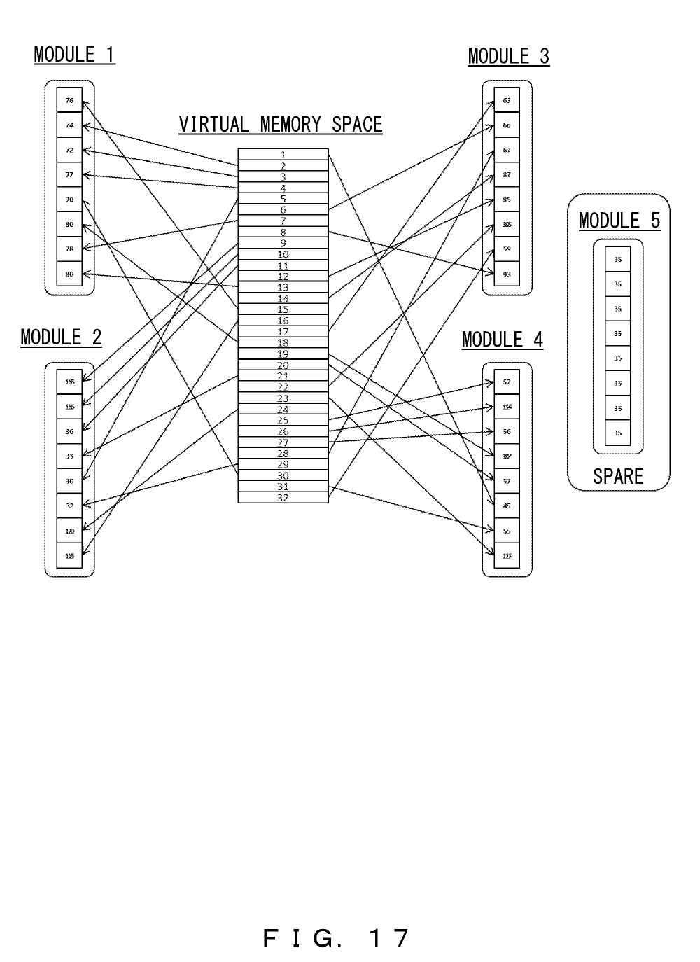

FIG. 17 illustrates an example of memory modules according to a third embodiment. Memory modules 1 to 4 according to the third embodiment are the same as the memory modules 1 to 4 of, for example, FIG. 4. The memory modules according to the third embodiment include a memory module 5 in addition to the memory modules 1 to 4. The memory module 5 is a spare memory module.

When the information processing apparatus is provided with a spare memory module as illustrated in FIG. 17, remapping processing is not performed on the spare memory module 5 such that the temperatures of the memory modules are equalized. Thus, the same remapping processing as the remapping processing performed on, for example, the memory modules of FIG. 4 is also performed on the information processing information provided with a spare memory module.

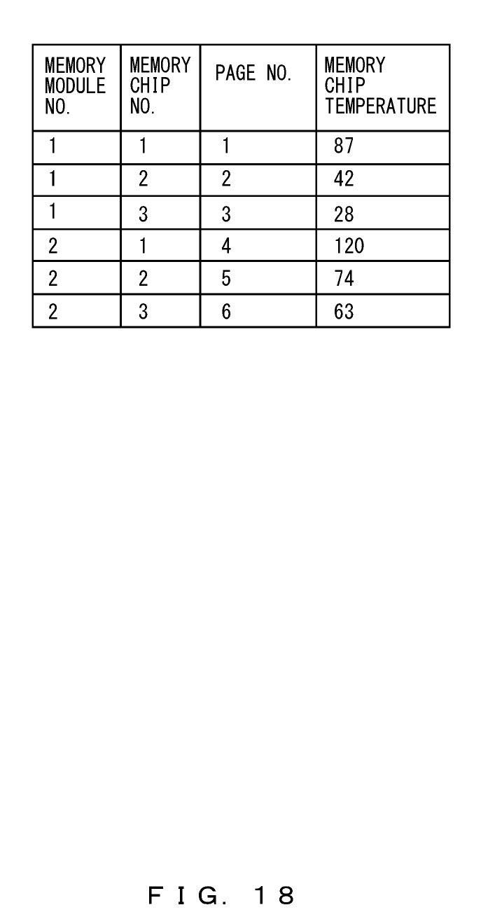

FIG. 18 is a diagram for explaining a temperature state of a memory module according to a fourth embodiment. In an information processing apparatus according to the fourth embodiment, it is possible to obtain, from among all of the combinations of assignment of pages to memory chips, a combination of assignment in which the temperature of a memory module is close to the average of the temperatures of all of the memory chips.

The information processing apparatus according to the fourth embodiment includes a memory module 1 and a memory module 2. The memory module 1 and the memory module 2 each include memory chips respectively having memory chip numbers 1 to 3. Pages respectively having page numbers 1 to 6 are assigned to the respective memory chips. The temperature of the memory chip, for the memory module 1, which has a memory chip number 1 (page 1) is 87 degrees. The temperature of the memory chip, for the memory module 1, which has a memory chip number 2 (page 2) is 42 degrees. The temperature of the memory chip, for the memory module 1, which has a memory chip number 3 (page 3) is 28 degrees. The temperature of the memory chip, for the memory module 2, which has a memory chip number 4 (page 4) is 120 degrees. The temperature of the memory chip, for the memory module 2, which has a memory chip number 2 (page 5) is 74 degrees. The temperature of the memory chip, for the memory module 2, which has a memory chip number 3 (page 6) is 63 degrees.

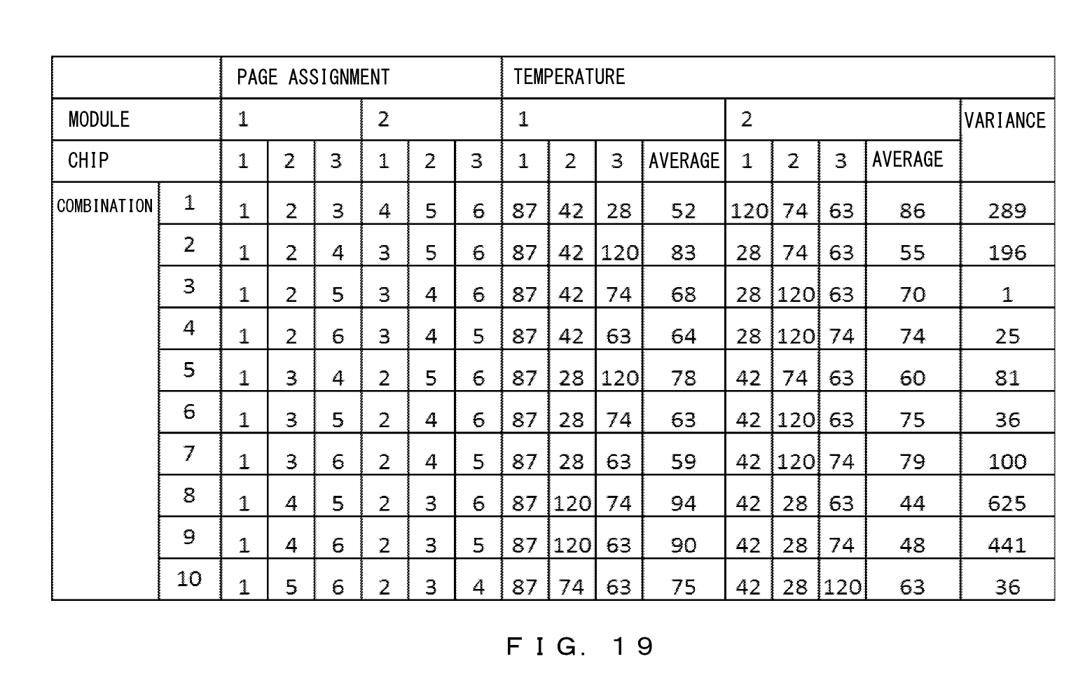

FIG. 19 is a diagram for explaining an example of processing of obtaining a combination of assignment of pages according to the fourth embodiment. The table illustrated in FIG. 19 includes categories such as a page assignment and a temperature. The category of the page assignment forms a list of combinations of assignment of pages to respective memory chips provided in the memory modules 1 and 2.

There are ten combinations of assignment of six pages. Specifically, a combination of assignment of six pages is obtained using “6C3÷2!”. In this formula, three pages assigned to the memory module 1 are selected from the six page numbers so as to forma combination, and permutations of the two memory modules are excluded.

Further, when the number of memory modules in the information processing apparatus is M and the number of memory chips in the memory module is C, a combination of assignment of pages is obtained using Formula 1 below:

(M×C)!(C!)^{M}×M! (1)

The category of the temperature in FIG. 19 indicates a temperature of a page assigned to each memory chip. The average of the temperatures of all of the memory chips is 69 degrees. The information processing apparatus selects, from all of the combinations of assignment of pages, a combination of assignment in which a difference in temperature is smallest. The difference in temperature is represented by, for example, a variance. The variance is obtained using Formula 2 below:

$${\sum }_{i = 0}^{n} \frac{{( {T}_{i} - A )}^{2}}{n} \qquad ( 2 )$$

Ti is a temperature of a memory module i. A is an average of the temperatures of all of the memory chips. n is the number of memory modules.

For example, in the example of a combination 1 of FIG. 19, pages having page numbers 1, 2, and 3 are assigned to the memory module 1, and pages having page numbers 4, 5, and 6 are assigned to the memory module 2. Then, the average temperature for the memory module 1 is 52 degrees. The average temperature for the memory module 2 is 86 degrees. Thus, the variance of the combination 1 is represented by Formula 3 in which these values are substituted into Formula 2.

(52−69)²÷2+(86−69)²÷2=289 (3)

The information processing apparatus calculates variances for all of the combinations of assignment. A page exchange is performed based on the combination of assignment of pages in which the variance (the difference in the temperatures of memory modules) is smallest, so that the temperatures of memory modules are equalized. This results in reducing consumption of power used for cooling.

All examples and conditional language provided herein are intended for the pedagogical purpose of aiding the reader in understanding the invention and the concepts contributed by the inventor to further the art, and are not to be construed as limitations to such specifically recited examples and conditions, nor does the organization of such examples in the specification related to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a temperature sensor configured to measure temperatures of a plurality of memory modules; and
a processor configured to perform a control to change memory addresses of the plurality of memory modules such that temperatures of the plurality of memory modules are equalized, the memory addresses of the plurality of memory modules being associated with memory addresses of pages that are assigned to a virtual memory in which the plurality of memory modules are virtually available.

2. The information processing apparatus according to claim 1, wherein
when there are a plurality of combinations of assignment of memory addresses of the pages to memory addresses of the plurality of memory modules in which the temperatures of the plurality of memory modules are equalized, the processor sets the memory addresses of the pages and the memory addresses of the plurality of memory modules according to a combination of assignment, among the plurality of combinations of assignment, in which the number of page exchanges is smallest.

3. The information processing apparatus according to claim 2, wherein
when the processor sets the memory addresses of the pages and the memory addresses of the plurality of memory modules according to the combination of assignment, among the plurality of combinations of assignment, in which the number of page exchanges is smallest, the processor determines an order of page exchange in order to avoid a page competition.

4. The information processing apparatus according to claim 2, wherein
the processor calculates a difference in temperature between a temperature of each of the plurality of memory modules and an average of the temperatures of the plurality of memory modules, and selects, to be the combination of assignment in which the number of page exchanges is smallest, a combination of assignment of memory addresses of the pages to memory addresses of the plurality of memory modules in which the difference in temperature is smallest.

5. The information processing apparatus according to claim 1, wherein
the processor
generates list information that includes a memory module temperature, a deviation from an average of the temperatures of the plurality of memory modules, and information on a memory address of a page that are associated with each of the plurality of memory modules, and
sets the memory addresses of the pages and the memory addresses of the plurality of memory modules using the list information.

6. A processor configured to
obtain temperatures of a plurality of memory modules from a temperature sensor, and
change memory addresses of the plurality of memory modules such that temperatures of the plurality of memory modules are equalized, the memory addresses of the plurality of memory modules being associated with memory addresses of pages that are included in a virtual memory in which the plurality of memory modules are virtually available.

7. The processor according to claim 6, wherein
when there are a plurality of combinations of assignment of memory addresses of the pages to memory addresses of the plurality of memory modules in which the temperatures of the plurality of memory modules are equalized, the processor sets the memory addresses of the pages and the memory addresses of the plurality of memory modules according to a combination of assignment, among the plurality of combinations of assignment, in which the number of page exchanges is smallest.

8. The processor according to claim 7, wherein
when the processor sets the memory addresses of the pages and the memory addresses of the plurality of memory modules according to the combination of assignment, among the plurality of combinations of assignment, in which the number of page exchanges is smallest, the processor determines an order of page exchange in order to avoid a page competition.

9. The processor according to claim 7, wherein
the processor calculates a difference in temperature between a temperature of each of the plurality of memory modules and an average of the temperatures of the plurality of memory modules, and selects, to be the combination of assignment in which the number of page exchanges is smallest, a combination of assignment of memory addresses of the pages to memory addresses of the plurality of memory modules in which the difference in temperature is smallest.

10. The processor according to claim 7, wherein
the processor
generates list information that includes a memory module temperature, a deviation from an average of temperatures of the plurality of memory modules, and information on a memory address of a page that are associated with each of the plurality of memory modules, and
sets the memory addresses of the pages and the memory addresses of the plurality of memory modules using the deviation in the list information.
